(19) United States
(12) Patent Application Publication
(10) Pub. No.: US 2018/0324819 A1
(43) Pub. Date: Nov. 8, 2018

(54) METHOD AND APPARATUS FOR TRANSMITTING INFORMATION IN POWER COMMUNICATIONS SYSTEM, AND SYSTEM

(71) Applicant: HUAWEI TECHNOLOGIES CO., LTD., Shenzhen (CN)

(72) Inventors: Yalin LIU, Shanghai (CN); Ganghua YANG, Boulogne Billancourt (FR); Jun ZHANG, Shenzhen (CN); Xiangjiang QIAN, Shenzhen (CN)

(21) Appl. No.: 16/040,246

(22) Filed: Jul. 19, 2018

Related U.S. Application Data
(63) Continuation of application No. PCT/CN2016/071444, filed on Jan. 20, 2016.

(51) Int. Cl. H04W 72/10; H04W 16/14; H04W 72/04; H04L 29/08

(52) U.S. Cl. CPC H04W 72/10; H04L 67/12; H04W 72/0453; H04W 16/14

(57) ABSTRACT

Embodiments of the present invention disclose a method and an apparatus for transmitting information in a power communications system, and a system. The method is applied to a power communications system that uses at least two frequency bands for wireless communication, frequency band licensing statuses of the at least two frequency bands are different, and the method includes: determining a target frequency band from the at least two frequency bands based on an information type of to-be-sent information and a correspondence between the information type and a frequency band; and sending the to-be-sent information by using the target frequency band.

### CROSS-REFERENCE TO RELATED APPLICATIONS

This application is a continuation of International Application No. PCT/CN2016/071444, filed on Jan. 20, 2016, the disclosure of which is hereby incorporated by reference in its entirety.

### TECHNICAL FIELD

The present invention relates to the communications field, and more specifically, to a method and an apparatus for transmitting information in a power communications system, and a system.

### BACKGROUND

Wireless communication is one of main communications means in power communication and is widely applied to power networks, and particularly to a smart grid. Currently, a power communications system usually uses a dedicated licensed frequency band for communication. For example, a 1-MHz dedicated frequency band on a 230 MHz frequency band is available for a power communications system in China. The dedicated licensed channel for the power communications system features a low frequency, a long wavelength, and a wide coverage area; however, it also has a disadvantage of relatively small bandwidth.

Different types of information in the power communications system have different features during transmission. For example, control information has a relatively high requirement on real-time transmission, while metering data occupies a great amount of bandwidth due to a high data throughput. Therefore, the existing dedicated licensed channel cannot desirably meet a communication requirement for different types of information. This affects wireless communication performance of the power communications system.

### SUMMARY

Embodiments of the present invention provide a method and an apparatus for transmitting information in a power communications system, and a system, so that performance of a power communications system can be improved.

According to a first aspect, a method for transmitting information in a power communications system is provided, where the method is applied to a power communications system that uses at least two frequency bands for wireless communication, frequency band licensing statuses of the at least two frequency bands are different, and the method includes: determining a target frequency band from the at least two frequency bands based on an information type of to-be-sent information and a correspondence between the information type and at least one of the frequency bands; and sending the to-be-sent information by using the target frequency band.

In one embodiment, when the target frequency band is determined from the at least two frequency bands, the target frequency band may further be determined based on an emergency degree of the to-be-sent information. The determining a target frequency band from the at least two frequency bands specifically includes: determining a candidate target frequency band from the at least two frequency bands based on the information type of the to-be-sent information and the correspondence between the information type and at least one of the frequency bands; and determining a target frequency band from the candidate target frequency band based on the emergency degree of the to-be-sent information. Therefore, the target frequency band can be determined based on the emergency degree of the to-be-sent information, so that transmission requirements of information of different emergency degrees can be met, and performance of the power communications system is improved.

In one embodiment, the at least two frequency bands include at least two of a dedicated licensed frequency band, a non-dedicated licensed frequency band, and an unlicensed frequency band that are used by the power communications system.

In one embodiment, the information type of the to-be-transmitted information includes a control type, a monitoring type, or a metering type.

In one embodiment, the determining a target frequency band from the at least two frequency bands based on an information type of to-be-sent information and a correspondence between the information type and at least one of the frequency bands specifically includes: determining the dedicated licensed frequency band as the target frequency band for the to-be-sent information if the information type of the to-be-sent information is the control type; determining the dedicated licensed frequency band, the unlicensed frequency band, or the non-dedicated licensed frequency band as the target frequency band for the to-be-sent information if the information type of the to-be-sent information is the monitoring type; or determining the unlicensed frequency band or the non-dedicated licensed frequency band as the target frequency band for the to-be-sent information if the information type of the to-be-sent information is the metering type. Therefore, the target frequency band can be determined based on the information type of the to-be-sent information and the correspondence between the information type and at least one of the frequency bands, so that a transmission requirement of control-type information for relatively high information QoS (quality of service) or channel reliability can be met, a transmission requirement of metering-type information for relatively large bandwidth but relatively low information QoS or channel reliability can be met, and the performance of the power communications system is improved.

In one embodiment, the determining the dedicated licensed frequency band, the unlicensed frequency band, or the non-dedicated licensed frequency band as the target frequency band for the to-be-sent information if the information type of the to-be-sent information is the monitoring type specifically includes: determining the unlicensed frequency band as the target frequency band for the to-be-sent information if the information type of the to-be-sent information is the monitoring type and the emergency degree of the to-be-sent information meets a first preset condition; determining the non-dedicated licensed frequency band as the target frequency band for the to-be-sent information if the information type of the to-be-sent information is the monitoring type and the emergency degree of the to-be-sent information meets a second preset condition; or determining the dedicated licensed frequency band as the target frequency band for the to-be-sent information if the information type of the to-be-sent information is the monitoring type and the emergency degree of the to-be-sent information meets a third preset condition, where an emergency degree corresponding to the third preset condition is higher than an emergency degree corresponding to the first preset condition and an emergency degree corresponding to the second preset condition. Therefore, the target frequency band can be determined based on an emergency degree of to-be-sent monitoring-type information, so that transmission requirements of monitoring-type information of different emergency degrees can be met, and the performance of the power communications system is improved.

In one embodiment, the dedicated licensed frequency band is a 230 MHz frequency band, the unlicensed frequency band is a 2.4 GHz frequency band or a 5 GHz frequency band, and the non-dedicated licensed frequency band is a 1.8 GHz frequency band.

According to a second aspect, a method for transmitting information in a power communications system is provided, where the method is applied to a power communications system that uses at least two frequency bands for wireless communication, licensing statuses of the at least two frequency bands are different, and the method includes: determining a target frequency band from the at least two frequency bands based on an emergency degree of to-be-sent information and a correspondence between the emergency degree and a frequency band; and sending the to-be-sent information by using the target frequency band.

In one embodiment, the at least two frequency bands include at least two of a dedicated licensed frequency band, a non-dedicated licensed frequency band, and an unlicensed frequency band that are used by the power communications system.

In one embodiment, the determining a target frequency band from the at least two frequency bands based on an emergency degree of to-be-sent information and a correspondence between the emergency degree and a frequency band specifically includes: determining the unlicensed frequency band as the target frequency band for the to-be-sent information if the emergency degree of the to-be-sent information meets a first preset condition; determining the non-dedicated licensed frequency band as the target frequency band for the to-be-sent information if the emergency degree of the to-be-sent information meets a second preset condition; or determining the dedicated licensed frequency band as the target frequency band for the to-be-sent information if the emergency degree of the to-be-sent information meets a third preset condition, where an emergency degree corresponding to the third preset condition is higher than an emergency degree corresponding to the first preset condition and an emergency degree corresponding to the second preset condition. Therefore, the target frequency band can be determined based on the emergency degree of the to-be-sent information, so that transmission requirements of information of different emergency degrees can be met, and performance of the power communications system is improved.

In one embodiment, the dedicated licensed frequency band is a 230 MHz frequency band, the unlicensed frequency band is a 2.4 GHz frequency band or a 5 GHz frequency band, and the non-dedicated licensed frequency band is a 1.8 GHz frequency band.

According to a third aspect, an apparatus for transmitting information in a power communications system is provided, where the apparatus is applied to a power communications system that uses at least two frequency bands for wireless communication, frequency band licensing statuses of the at least two frequency bands are different, and the apparatus includes: a determining module, configured to determine a target frequency band from the at least two frequency bands based on an information type of to-be-sent information and a correspondence between the information type and at least one of the frequency bands; and a sending module, configured to send the to-be-sent information by using the target frequency band determined by the determining module.

In one embodiment, the determining module includes: a first determining unit, configured to determine a candidate target frequency band from the at least two frequency bands based on the information type of the to-be-sent information and the correspondence between the information type and at least one of the frequency bands; and a second determining unit, configured to determine a target frequency band from the candidate target frequency band based on an emergency degree of the to-be-sent information. Therefore, the target frequency band can be determined based on the emergency degree of the to-be-sent information, so that transmission requirements of information of different emergency degrees can be met, and performance of the power communications system is improved.

In one embodiment, the at least two frequency bands include at least two of a dedicated licensed frequency band, a non-dedicated licensed frequency band, and an unlicensed frequency band that are used by the power communications system.

In one embodiment, the information type of the to-be-transmitted information includes a control type, a monitoring type, or a metering type.

In one embodiment, the determining module is specifically configured to: determine the dedicated licensed frequency band as the target frequency band for the to-be-sent information if the information type of the to-be-sent information is the control type; determine the dedicated licensed frequency band, the unlicensed frequency band, or the non-dedicated licensed frequency band as the target frequency band for the to-be-sent information if the information type of the to-be-sent information is the monitoring type; or determine the unlicensed frequency band or the non-dedicated licensed frequency band as the target frequency band for the to-be-sent information if the information type of the to-be-sent information is the metering type. Therefore, the target frequency band can be determined based on the information type of the to-be-sent information and the correspondence between the information type and at least one of the frequency bands, so that a transmission requirement of control-type information for relatively high information QoS or channel reliability can be met, a transmission requirement of metering-type information for relatively large bandwidth but relatively low information QoS or channel reliability can be met, and the performance of the power communications system is improved.

In one embodiment, when the information type of the to-be-sent information is the monitoring type, and the dedicated licensed frequency band, the unlicensed frequency band, or the non-dedicated licensed frequency band is determined as the target frequency band for the to-be-sent information, the determining module is specifically configured to: determine the unlicensed frequency band as the target frequency band for the to-be-sent information if the information type of the to-be-sent information is the monitoring type and the emergency degree of the to-be-sent information meets a first preset condition; determine the non-dedicated licensed frequency band as the target frequency band for the to-be-sent information if the information type of the to-be-sent information is the monitoring type and the emergency degree of the to-be-sent information meets a second preset condition; or determine the dedicated licensed frequency band as the target frequency band for the to-be-sent information if the information type of the to-be-sent information is the monitoring type and the emergency degree of the to-be-sent information meets a third preset condition, where an emergency degree corresponding to the third preset condition is higher than an emergency degree corresponding to the first preset condition and an emergency degree corresponding to the second preset condition. Therefore, the target frequency band can be determined based on an emergency degree of to-be-sent monitoring-type information, so that transmission requirements of monitoring-type information of different emergency degrees can be met, and the performance of the power communications system is improved.

In one embodiment, the dedicated licensed frequency band is a 230 MHz frequency band, the unlicensed frequency band is a 2.4 GHz frequency band or a 5 GHz frequency band, and the non-dedicated licensed frequency band is a 1.8 GHz frequency band.

According to a fourth aspect, an apparatus for transmitting information in a power communications system is provided, where the apparatus is applied to a power communications system that uses at least two frequency bands for wireless communication, frequency band licensing statuses of the at least two frequency bands are different, and the apparatus includes: a determining module, configured to determine a target frequency band from the at least two frequency bands based on an emergency degree of to-be-sent information and a correspondence between the emergency degree and a frequency band; and a sending module, configured to send the to-be-sent information by using the target frequency band determined by the determining module.

In one embodiment, the at least two frequency bands include at least two of a dedicated licensed frequency band, a non-dedicated licensed frequency band, and an unlicensed frequency band that are used by the power communications system.

In one embodiment, the determining module is specifically configured to: determine the unlicensed frequency band as the target frequency band for the to-be-sent information if the emergency degree of the to-be-sent information meets a first preset condition; determine the non-dedicated licensed frequency band as the target frequency band for the to-be-sent information if the emergency degree of the to-be-sent information meets a second preset condition; or determine the dedicated licensed frequency band as the target frequency band for the to-be-sent information if the emergency degree of the to-be-sent information meets a third preset condition, where an emergency degree corresponding to the third preset condition is higher than an emergency degree corresponding to the first preset condition and an emergency degree corresponding to the second preset condition. Therefore, the target frequency band can be determined based on the emergency degree of the to-be-sent information, so that transmission requirements of information of different emergency degrees can be met, and performance of the power communications system is improved.

In one embodiment, the dedicated licensed frequency band is a 230 MHz frequency band, the unlicensed frequency band is a 2.4 GHz frequency band or a 5 GHz frequency band, and the non-dedicated licensed frequency band is a 1.8 GHz frequency band.

According to a fifth aspect, a device for transmitting information in a power communications system is provided, where the device is applied to a power communications system that uses at least two frequency bands for wireless communication, frequency band licensing statuses of the at least two frequency bands are different, and the device includes: a processor, a memory, a bus system, and a transceiver. The processor, the memory, and the transceiver are connected by using the bus system; the memory is configured to store an instruction; the processor is configured to execute the instruction stored in the memory, so as to control the transceiver to receive or send a signal; and when the processor executes the instruction stored in the memory, the execution causes the processor to perform the method in the first aspect or any possible implementation of the first aspect.

According to a sixth aspect, a device for transmitting information in a power communications system is provided, where the device is applied to a power communications system that uses at least two frequency bands for wireless communication, frequency band licensing statuses of the at least two frequency bands are different, and the device includes: a processor, a memory, a bus system, and a transceiver. The processor, the memory, and the transceiver are connected by using the bus system; the memory is configured to store an instruction; the processor is configured to execute the instruction stored in the memory, so as to control the transceiver to receive or send a signal; and when the processor executes the instruction stored in the memory, the execution causes the processor to perform the method in the second aspect or any possible implementation of the second aspect.

According to a seventh aspect, a power communications system is provided, where the communications system uses at least two frequency bands for wireless communication, frequency band licensing statuses of the at least two frequency bands are different, and the power communications system includes a plurality of communications devices and performs power communication by sending and receiving information, where there is a correspondence between an information type of the information sent by the communications device and the frequency band, and when performing the power communication, the communications device sends the information by using a frequency band corresponding to the information type of the information.

In one embodiment, when the communications device sends the information by using the frequency band corresponding to the information type of the to-be-sent information, the method further includes: when the information type of the to-be-sent information corresponds to at least two frequency bands, determining a target frequency band from the at least two frequency bands based on an emergency degree of the to-be-sent information, and sending the to-be-sent information by using the target frequency band. Therefore, the target frequency band can be determined based on the emergency degree of the to-be-sent information, so that transmission requirements of information of different emergency degrees can be met, and performance of the power communications system is improved.

In one embodiment, the at least two frequency bands include at least two of a dedicated licensed frequency band, a non-dedicated licensed frequency band, and an unlicensed frequency band that are used by the power communications system; the information type includes a control type, a monitoring type, or a metering type; and that when performing the power communication, the communications device sends the to-be-sent information by using a frequency band corresponding to the information type of the to-be-sent information specifically includes: sending, by the communications device, the information by using the dedicated licensed frequency band if the information type of the to-be-sent information is the control type; sending, by the communications device, the information by using the dedicated licensed frequency band, the unlicensed frequency band, or the non-dedicated licensed frequency band if the information type of the to-be-sent information is the monitoring type; or sending, by the communications device, the information by using the unlicensed frequency band or the non-dedicated licensed frequency band if the information type of the to-be-sent information is the metering type. Therefore, the target frequency band can be determined based on the information type of the to-be-sent information and the correspondence between the information type and at least one of the frequency bands, so that a transmission requirement of control-type information for relatively high information QoS or channel reliability can be met, a transmission requirement of metering-type information for relatively large bandwidth but relatively low information QoS or channel reliability can be met, and the performance of the power communications system is improved.

In one embodiment, the sending, by the communications device, the information by using the dedicated licensed frequency band, the unlicensed frequency band, or the non-dedicated licensed frequency band if the information type of the to-be-sent information is the monitoring type specifically includes: if the information type of the to-be-sent information is the monitoring type and the emergency degree of the to-be-sent information meets a first preset condition, determining the unlicensed frequency band as the target frequency band for the to-be-sent information, and sending the to-be-sent information by using the target frequency band; if the information type of the to-be-sent information is the monitoring type and the emergency degree of the to-be-sent information meets a second preset condition, determining the non-dedicated licensed frequency band as the target frequency band for the to-be-sent information, and sending the to-be-sent information by using the target frequency band; or if the information type of the to-be-sent information is the monitoring type and the emergency degree of the to-be-sent information meets a third preset condition, determining the dedicated licensed frequency band as the target frequency band for the to-be-sent information, and sending the to-be-sent information by using the target frequency band, where an emergency degree corresponding to the third preset condition is higher than an emergency degree corresponding to the first preset condition and an emergency degree corresponding to the second preset condition. Therefore, the target frequency band can be determined based on an emergency degree of to-be-sent monitoring-type information, so that transmission requirements of monitoring-type information of different emergency degrees can be met, and the performance of the power communications system is improved.

According to an eighth aspect, a power communications system is provided, where the power communications system uses at least two frequency bands for wireless communication, frequency band licensing statuses of the at least two frequency bands are different, the power communications system includes a plurality of communications devices, and the plurality of communications devices perform power communication by sending and receiving information, where the communications device determines a target frequency band from the at least two frequency bands based on an emergency degree of to-be-sent information and a correspondence between the emergency degree and the frequency band, and sends the to-be-sent information by using the target frequency band.

In one embodiment, the at least two frequency bands include at least two of a dedicated licensed frequency band, a non-dedicated licensed frequency band, and an unlicensed frequency band that are used by the power communications system.

In one embodiment, the unlicensed frequency band is determined as the target frequency band for the to-be-sent information if the emergency degree of the to-be-sent information meets a first preset condition; the non-dedicated licensed frequency band is determined as the target frequency band for the to-be-sent information if the emergency degree of the to-be-sent information meets a second preset condition; or the dedicated licensed frequency band is determined as the target frequency band for the to-be-sent information if the emergency degree of the to-be-sent information meets a third preset condition, where an emergency degree corresponding to the third preset condition is higher than an emergency degree corresponding to the first preset condition and an emergency degree corresponding to the second preset condition.

According to a ninth aspect, a computer-readable medium is provided, and is configured to store a computer program. The computer program includes an instruction used to perform the method in the first aspect or the second aspect or any possible implementation of the foregoing two aspects.

According to the method, apparatus, and device for transmitting information in a power communications system, and the system that are provided in the embodiments of the present invention, the target frequency band is determined from the at least two frequency bands based on the information type or the emergency degree of the to-be-sent information, and the to-be-sent information is sent by using the target frequency band, so that the frequency band licensing status of the selected target frequency band can be adapted to the information type or the emergency degree of the to-be-sent information, transmission requirements of information of different information types or different emergency degrees can be flexibly met, and the performance of the power communications system is improved.

### BRIEF DESCRIPTION OF DRAWINGS

To describe the technical solutions in the embodiments of the present invention more clearly, the following briefly describes the accompanying drawings required for describing the embodiments of the present invention. Apparently, the accompanying drawings in the following description show merely some embodiments of the present invention, and a person of ordinary skill in the art may still derive other drawings from these accompanying drawings without creative efforts.

FIG. 1 is a schematic diagram of a communications system to which a method for transmitting information according to an embodiment of the present invention is applicable;

FIG. 2 is a schematic block diagram of a sensor according to an embodiment of the present invention;

FIG. 3 is a schematic flowchart of a method for transmitting information in a power communications system according to an embodiment of the present invention;

FIG. 4 is another schematic flowchart of a method for transmitting information in a power communications system according to an embodiment of the present invention;

FIG. 5 is a schematic block diagram of an apparatus for transmitting information in a power communications system according to an embodiment of the present invention;

FIG. 6 is another schematic block diagram of an apparatus for transmitting information in a power communications system according to an embodiment of the present invention;

FIG. 7 is a schematic block diagram of a device for transmitting information in a power communications system according to an embodiment of the present invention;

FIG. 8 is another schematic block diagram of a device for transmitting information in a power communications system according to an embodiment of the present invention;

FIG. 9 is a schematic block diagram of a power communications system according to an embodiment of the present invention; and

FIG. 10 is another schematic block diagram of a power communications system according to an embodiment of the present invention.

### DESCRIPTION OF EMBODIMENTS

The following clearly describes the technical solutions in the embodiments of the present invention with reference to the accompanying drawings in the embodiments of the present invention. Apparently, the described embodiments are some but not all of the embodiments of the present invention. All other embodiments obtained by a person of ordinary skill in the art based on the embodiments of the present invention without creative efforts shall fall within the protection scope of the present invention.

It should be understood that a power communications system in the embodiments of the present invention may use various wireless communication solutions for communication, such as a Global System for Mobile Communications (GSM), a Code Division Multiple Access (CDMA) system, a Wideband Code Division Multiple Access (WCDMA) system, a general packet radio service (GPRS,) system, a Long Term Evolution (LTE) system, and a wireless local area network (WLAN).

It should be further understood that in the embodiments of the present invention, a transmit end device or a receive end device may be a terminal device of the power communications system, the terminal device may communicate with one or more network side devices by using a radio access network (RAN), and the terminal device may include an electric brake, a sensor, or a smart meter.

It should be further understood that in the embodiments of the present invention, the transmit end device or the receive end device may be a network side device of the power communications system, the network side device may be configured to communicate with a terminal device, and the network device may be a base transceiver station (BTS) in a GSM system or in a CDMA system, may be a NodeB (Node B) in a WCDMA system, or may be an evolved NodeB (eNB) in an LTE system. Alternatively, the network side device may be a relay node, an access point, an in-vehicle device, a wearable device, a base station device on a future 5G network, or the like.

According to a method, an apparatus and a device for transmitting data in a power communications system in the embodiments of the present invention, at least two frequency bands may be used for wireless communication, and frequency band licensing statuses of the at least two frequency bands are different. Specifically, the at least two frequency bands include at least two of a dedicated licensed frequency band (or referred to as “a dedicated frequency band”), an unlicensed frequency band, and a non-dedicated licensed frequency band that are used by the power communications system. That is, the at least two frequency bands may include the dedicated licensed frequency band and the unlicensed frequency band, or may include the dedicated licensed frequency band and the non-dedicated licensed frequency band, or may include the unlicensed frequency band and the non-dedicated licensed frequency band, or may include the dedicated licensed frequency band, the unlicensed frequency band, and the non-dedicated licensed frequency band.

The dedicated licensed frequency band for the power communications system is granted only for the power industry, and a device does not need to apply for a grant or contend for a channel when the device uses the frequency band. Therefore, the dedicated licensed frequency band has a relatively reliable information transmission capability and can be used to transmit information that requires relatively high QoS or reliability. The unlicensed frequency band is available for all industries, bandwidth of the frequency band is relatively large, and a device does not need to apply for a grant when the device uses the frequency band. However, the frequency band is interference-prone, and the device needs to contend for a channel when the device uses the frequency band. Therefore, the unlicensed frequency band is suitable for transmitting information that is of a great volume and that requires relatively low reliability or QoS. The non-dedicated licensed frequency band has relatively large bandwidth and a relatively high reliability, and a device does not need to contend for a channel when the device uses the frequency band. However, the frequency band is allocated for different industries in different regions. Therefore, the non-dedicated licensed frequency band is suitable for transmitting information that requires reliability and that is transmitted only in a local area instead of across a country.

A target frequency band in the embodiments of the present invention is a frequency band to be used that is determined from the at least two frequency bands by the power communications system.

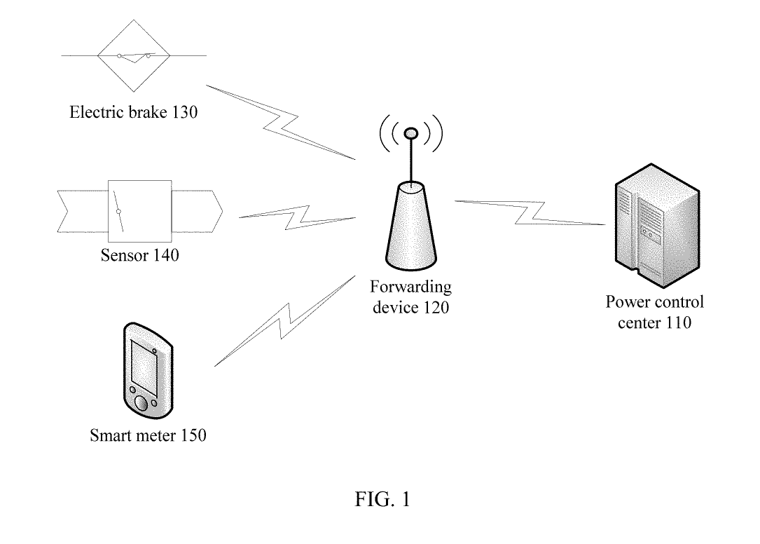

FIG. 1 is a schematic diagram applicable to a method for transmitting information in a power communications system according to an embodiment of the present invention. It should be noted that an example in FIG. 1 is only to help a person skilled in the art to better understand this embodiment of the present invention instead of limiting the scope of this embodiment of the present invention. For example, in FIG. 1, an electric brake 130, a sensor 140, and a smart meter 150 are all power terminal devices, and a forwarding device 120 and a power control center 110 are network side devices. FIG. 1 shows one electric brake, one sensor, one smart meter, one forwarding device, and one electric control center, but a quantity of power terminal devices and a quantity of network side devices may alternatively be other quantities, and this is not limited in this embodiment of the present invention. To be specific, this embodiment of the present invention may include only one power terminal device and one network side device, or may include one power terminal device and a plurality of network side devices, or may include a plurality of power terminal devices and one network side device, or may include a plurality of power terminal devices and a plurality of network side devices.

It should be understood that this embodiment of the present invention may include one type of power terminal device and one type of network side device, or may include one type of power terminal device and a plurality of types of network side devices, or may include a plurality of types of power terminal devices and one type of network side device, or may include a plurality of types of power terminal devices and a plurality of types of network side devices.

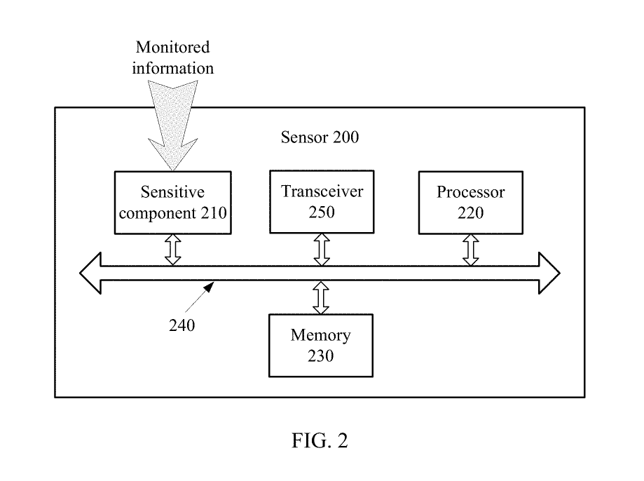

It should be further understood that a power terminal device may send information to a network side device by using different frequency bands, and receive, by using different frequency bands, information sent by the network side device. As shown in FIG. 2, FIG. 2 shows a sensor 200 that can receive or send information as an example. The sensor 200 includes a sensitive component 210, a processor 220, a memory 230, a bus system 240, and a transceiver 250. The sensitive component 210, the processor 220, the memory 230, and the transceiver 250 are connected by using the bus system 240. The sensitive component 210 directly senses measured information, such as temperature information, and converts the measured information into an electrical signal. The memory 230 is configured to store an instruction, and the processor 220 is configured to execute the instruction stored in the memory 230, so as to control the transceiver to receive or send a signal.

In a power communications system, an electric brake is a control-type terminal, and both open and close of the electric brake are controlled by control information sent by the system; the sensor is a monitoring-type terminal and can monitor information such as a cable temperature and current intensity; and data recorded by a smart meter is metering-type information. Therefore, information transmitted in the power communications system may include control-type information, monitoring-type information, and metering-type information.

Currently, the following frequency bands are available for a power communications system in some countries. (1) Dedicated licensed frequency band (for example, a 230 MHz frequency band): A 1-MHz-wide dedicated frequency band is available for the power communications system on the frequency band. However, the 1-MHz-wide dedicated frequency band is not a continuous spectrum but a series of discrete frequencies, and a special spectrum aggregation technology needs to be used to utilize the 1-MHz-wide dedicated frequency band. As shown in Table 1 and Table 2, bandwidth of each discrete frequency is 25 KHz, and there are 40 frequency channel numbers in total, that is, 1 MHz bandwidth in total. The frequency band has advantages of a low frequency, a long wavelength, and a wide coverage area. (2) Non-dedicated licensed frequency band (for example, a 1.8 GHz frequency band): The frequency band is entirely available for various industries and is not dedicated for the power communications system. Currently, the frequency band has been applied to power, airport, shipping, railway, road transportation, and subway in various cities. The frequency band has an advantage of large bandwidth that may be as large as 20 MHz (1785 MHz to 1805 MHz). (3) Unlicensed frequency band, such as a 2.4 GHz frequency band or a 5 GHz frequency band: The frequency band has an advantage of large bandwidth that may be as large as 80 MHz, or even 160 MHz. However, disadvantages are that the frequency band is unreliable because there is interference on the frequency band, and that a transmit end device is not necessarily able to obtain a channel through contention and information transmission may be delayed because the channel is shared.

TABLE 1
Dedicated frequencies for power (1)

| | Frequency | Frequency | Transmit Frequency |
|---|---|---|---|
| Item | Group | Number | (MHz) |
| Single-frequency | F1 | F1-3 | 228.075 |
| networking | | F1-5 | 228.125 |
| | | F1-7 | 228.175 |
| | | F1-10 | 228.250 |
| | | F1-13 | 228.325 |
| | | F1-16 | 228.400 |
| | | F1-19 | 228.475 |
| | | F1-22 | 228.550 |
| | | F1-27 | 228.675 |
| | | F1-30 | 228.750 |

TABLE 2
Dedicated frequencies for power (2)

| | | | Transmit Frequency (MHz) | |
|---|---|---|---|---|
| | Frequency | Frequency | | Secondary |
| Item | Group | Number | Primary station | station |
| dual-frequency | F3 | F3-21 | 230.525 | 233.525 |
| networking | | F3-27 | 230.675 | 233.675 |
| | | F3-29 | 230.725 | 233.725 |
| | | F3-34 | 230.850 | 233.850 |
| | | F3-38 | 230.950 | 233.950 |
| | | F3-41 | 231.025 | 234.025 |
| | | F3-45 | 231.125 | 234.125 |
| | | F3-47 | 231.175 | 234.175 |
| | | F3-49 | 231.225 | 234.225 |
| | F4 | F4-3 | 231.325 | 224.325 |
| | | F4-7 | 231.425 | 224.425 |
| | | F4-9 | 231.475 | 224.475 |
| | | F4-11 | 231.525 | 224.525 |
| | | F4-13 | 231.575 | 224.575 |
| | | F4-16 | 231.650 | 224.650 |

Specifically, for monitoring-type information collected by the sensor, a data packet may be generated based on an LTE-A (LTE-Advanced) frame format, and is sent to a base station by using the 230 MHz frequency band or the 1.8 GHz frequency band; or a data packet may be generated based on a frame format in the IEEE (Institute of Electrical and Electronics Engineers, Institute of Electrical and Electronics Engineers) 802.11ac standard, and is sent to an access point by using the 2.4 GHz frequency band and/or the 5 GHz frequency band. After collecting metering-type information, the smart meter may generate a data packet based on the frame format in the IEEE 802.11ac standard and send the data packet to the access point by using the 2.4 GHz frequency band and/or the 5 GHz frequency band, or may generate a data packet based on the LTE-A frame format and send the data packet to the base station by using the 1.8 GHz frequency band.

Correspondingly, the electric brake may receive, by using the 230 MHz frequency band, information sent by the base station. The sensor may receive, by using the 230 MHz frequency band or the 1.8 GHz frequency band, information sent by the base station, and may also receive, by using the 2.4 GHz frequency band and/or the 5 GHz frequency band, information sent by the access point. The smart meter may receive, by using the 2.4 GHz frequency band and/or the 5 GHz frequency band, information sent by the access point, and may also receive, by using the 1.8 GHz frequency band, information sent by the base station.

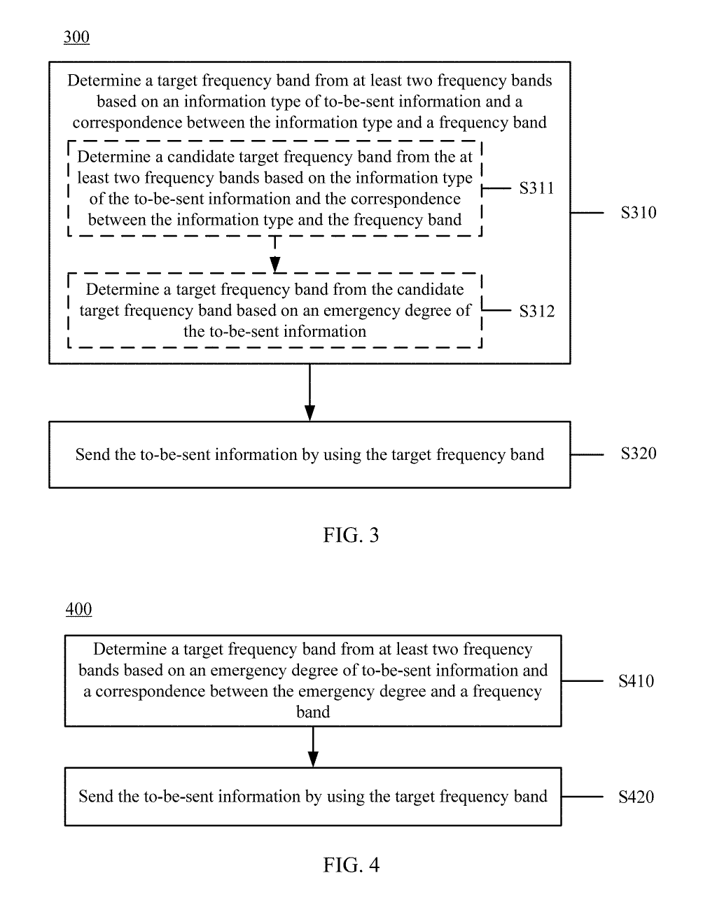

FIG. 3 is a schematic flowchart of a method for transmitting information in a power communications system according to an embodiment of the present invention. The method shown in FIG. 3 may be performed by a transmit end device, and the transmit end device may be the electric brake 130, the sensor 140, or the smart meter 150 in FIG. 1, may be the power control center 110 in FIG. 1, or may be the forwarding device 120 in FIG. 1. As shown in FIG. 3, the method 300 includes the following operations.

Operation S310. Determine a target frequency band from at least two frequency bands based on an information type of to-be-sent information and a correspondence between the information type and at least one of the at least two frequency bands.

Operation S320. Send the to-be-sent information by using the target frequency band.

In operation S310, in one embodiment, the transmit end device first needs to determine an available frequency band, and after obtaining the to-be-sent information, the transmit end device determines, based on the information type of the to-be-sent information, the frequency band for sending the to-be-sent information. In this embodiment of the present invention, the transmit end device may be a terminal device (that is, case 1), or may be a network side device (that is, case 2). The following separately describes the foregoing two cases.

Case 1

In one embodiment, that the terminal device determines, based on the information type of the to-be-sent information, the frequency band for sending the to-be-sent information includes:

if the to-be-sent information is monitoring-type information, the terminal device may determine to use a dedicated licensed frequency band, a non-dedicated licensed frequency band, or an unlicensed frequency band of a communications system to send the to-be-sent information, where specifically, when the power communications system determines that currently available frequency bands are a 230 MHz frequency band and a 2.4 GHz frequency band, since a sensor is a monitoring-type terminal device and cable temperature information collected by the sensor is monitoring-type information, the sensor may determine to use the 230 MHz frequency band to send the information, or determine to use the 2.4 GHz frequency band to send the information, or determine not to send the information; and optionally, if the power communications system further successfully applies for permission to use a 1.8 GHz frequency band, the sensor may alternatively determine to use the 1.8 GHz frequency band to send the monitoring-type information; or

if the to-be-sent information is metering-type information, the terminal device may determine to use a non-dedicated licensed frequency band or an unlicensed frequency band of a communications system to send the to-be-sent information, where specifically, when the power communications system determines that currently available frequency bands are a 230 MHz frequency band and a 2.4 GHz frequency band, since a smart meter is a metering-type terminal device and user power usage readings information collected by the smart meter is metering-type information, the smart meter may determine to use the 2.4 GHz frequency band to send the information; and if the power communications system further successfully applies for permission to use a 1.8 GHz frequency band, the smart meter may alternatively determine to use the 1.8 GHz frequency band to send the user power usage readings information.

Correspondingly, a receive end device may detect a signal on a corresponding frequency band according to a rule that is agreed upon in advance, so as to prepare for receiving the information sent by the terminal device.

It should be understood that the foregoing embodiment is merely an example for description, and this embodiment of the present invention is not limited thereto. For example, information collected by the sensor may alternatively be current intensity information. The specific frequency bands listed above are also merely used for ease of understanding. Any method that can be used to determine a target frequency band from at least two frequency bands based on an information type of to-be-sent information and a correspondence between the information type and at least one of the at least two frequency bands shall fall within the protection scope of the present invention.

Case 2

In one embodiment, that the network side device determines, based on the information type of the to-be-sent information, the frequency band for sending the to-be-sent information includes:

when the network side device is a control type device in a power communications network, the network side device may send control-type information to another device, and the network device may determine to use a dedicated licensed frequency band in a communications system to send the to-be-sent information. For example, when the network side device is a control center of the power communications system, the power communications system determines that currently available frequency bands are a 230 MHz frequency band and a 2.4 GHz frequency band. When the control center is about to send, to an electric brake, information instructing to close the brake, since the information is control-type information, the control center may determine to use the 230 MHz frequency band to send the information, and the information may be forwarded by a base station or may be sent by a data radio station.

In one embodiment, the network side device may also be a forwarding type device, and may receive information sent by another device and forward the information to a corresponding device. In this case, the network side device may determine a target frequency band based on an information type of the received information and a correspondence between the information type and at least one of the at least two frequency bands. Specifically, a base station may receive information that is sent by a power control center and that is used to command a smart meter to upload power usage readings. Because the information is control-type information, the base station may determine to use the 230 MHz frequency band to send the information to the smart meter. Alternatively, an access point may receive the information and determine to use the 2.4 GHz frequency band to forward the information. Alternatively, a base station or an access point may receive cable temperature information or current intensity information sent by a sensor, and forward the information to the control center by using the 230 MHz frequency band or the 2.4 GHz frequency band.

Correspondingly, a receive end device may detect a signal on a corresponding frequency band according to a rule that is agreed upon in advance, so as to prepare for receiving the information sent by the network side device.

In operation S320, specifically, after determining the target frequency band for the to-be-sent information, the transmit end device generates a data packet in a corresponding format based on a type of a network used by the target frequency band, and sends the to-be-sent information.

For example, if the transmit end device determines to use the 230 MHz frequency band to send information, a data packet may be generated based on an LTE-A frame format, or a data packet may be generated based on a frame format of another cellular network, or a corresponding data packet may be generated based on a data format of a data radio station. If the terminal device determines to use the 2.4 GHz frequency band to send information, a data packet may be generated based on a frame format in the IEEE 802.11ac standard. If the system further successfully applies for permission to use the 1.8 GHz frequency band and the 1.8 GHz frequency band is determined to be used to send information, a data packet may be generated based on the LTE-A frame format, or a corresponding data packet may be generated based on another network supported by the 1.8 GHz frequency band.

It should be understood that the foregoing embodiment is merely an example for description, and this embodiment of the present invention is not limited thereto. Any power communications network that allows information to be transmitted by using at least two frequency bands and that can adapt a frequency band licensing status of a selected target frequency band to an information type of to-be-sent information shall fall within the protection scope of the present invention.

Therefore, according to the method for transmitting information in a power communications system provided in this embodiment of the present invention, the target frequency band is determined from the at least two frequency bands based on the information type of the to-be-sent information, and the to-be-sent information is sent by using the target frequency band, so that a frequency band licensing status of the selected target frequency band can be adapted to the information type of the to-be-sent information, transmission requirements of information of different information types can be flexibly met, and performance of the power communications system is improved.

In one embodiment, when the target frequency band is determined from the at least two frequency bands, the target frequency band may further be determined based on an emergency degree of the to-be-sent information. The determining a target frequency band from at least two frequency bands in the method 300 specifically includes the following steps.

Operation S311. Determine a candidate target frequency band from the at least two frequency bands based on the information type of the to-be-sent information and the correspondence between the information type and at least one of the at least two frequency bands.

Operation S312. Determine a target frequency band from the candidate target frequency band based on an emergency degree of the to-be-sent information.

For example, the power communications system determines that information collected by a power sensor is monitoring-type information; therefore, at least two of the dedicated licensed frequency band, the non-dedicated licensed frequency band, and the unlicensed frequency band may be determined as candidate target frequency bands. If the power sensor collects information indicating that a cable temperature is the same as an ambient temperature, the power communications system may determine that the information is information of a relatively low emergency degree, and may further determine the unlicensed frequency band as a target frequency band for the information. If the power sensor collects information indicating that a cable temperature is 5 degrees Celsius higher than an ambient temperature, the power communications system may determine that the information is information of a relatively high emergency degree, and may further determine a licensed frequency band as a target frequency band for the information.

For another example, the power communications system determines that information sent by a power control center is control-type information; therefore, the dedicated licensed frequency band and the non-dedicated licensed frequency band may be determined as candidate target frequency bands. If the power control center sends, to an electric brake, information instructing to open the electric brake, the power communications system may determine that the information is information of a relatively high emergency degree, and may further determine the dedicated licensed frequency band as a target frequency band for the information. If the power control center sends, to the smart meter, information instructing to report power usage readings, the power communications system may determine that the information is information of a relatively low emergency degree, and may further determine the non-dedicated licensed frequency band as a target frequency band for the information.

It should be understood that the foregoing embodiment is merely an example for description, and this embodiment of the present invention is not limited thereto. Any power communications network that allows information to be transmitted by using at least two frequency bands and that can adapt a frequency band licensing status of a selected target frequency band to an emergency degree of to-be-sent information shall fall within the protection scope of the present invention.

Therefore, according to the method for transmitting information in a power communications system provided in this embodiment of the present invention, the target frequency band may be determined based on the emergency degree of the to-be-sent information, so that transmission requirements of information of different emergency degrees can be met, and performance of the power communications system is improved.

In one embodiment, the at least two frequency bands used by the power communications system in the method 300 include at least two of the dedicated licensed frequency band, the non-dedicated licensed frequency band, and the unlicensed frequency band.

In one embodiment, the information type of the to-be-transmitted information in the method 300 includes a control type, a monitoring type, or a metering type.

In one embodiment, the determining a target frequency band from at least two frequency bands based on an information type of to-be-sent information and a correspondence between the information type and at least one of the at least two frequency bands in the method 300 specifically includes the following operations.

Operation S313. Determine the dedicated licensed frequency band as the target frequency band for the to-be-sent information if the information type of the to-be-sent information is the control type.

Operation S314. Determine the dedicated licensed frequency band, the unlicensed frequency band, or the non-dedicated licensed frequency band as the target frequency band for the to-be-sent information if the information type of the to-be-sent information is the monitoring type.

Operation S315. Determine the unlicensed frequency band or the non-dedicated licensed frequency band as the target frequency band for the to-be-sent information if the information type of the to-be-sent information is the metering type.

In one embodiment, if the to-be-sent information is information sent by the control center to the electric brake, such as information instructing to open the electric brake, the power communications system may determine that the information is control-type information, so as to determine the dedicated licensed frequency band as a target frequency band for the information based on that the control-type information requires relatively high QoS or transmission reliability and that the dedicated licensed frequency band features relatively high reliability. If the to-be-sent information is information sent by the power sensor to the control center, such as cable temperature information, the power communications system may determine that the information is monitoring-type information, so as to determine the dedicated licensed frequency band, the unlicensed frequency band, or the non-dedicated licensed frequency band as a target frequency band for the information based on a specific case that the monitoring-type information requires ordinary QoS or transmission reliability. If the to-be-sent information is information sent by the smart meter to the control center, such as user power usage readings information, the power communications system may determine that the information is metering-type information, so as to determine the unlicensed frequency band or the non-dedicated licensed frequency band as a target frequency band for the information based on that the metering-type information requires relatively low QoS or transmission reliability but relatively large bandwidth and that the unlicensed frequency band or the non-dedicated licensed frequency band features relatively low reliability but relatively large bandwidth.

It should be understood that the foregoing embodiment is merely an example for description, and this embodiment of the present invention is not limited thereto. For example, the control-type information may further be information used by the control center to command the sensor to change a monitoring period. Any method that can be used to determine, in a power communications system, a target frequency band based on an information type of to-be-sent information and a correspondence between the information type and a transmission feature of at least one of the at least two frequency bands shall fall within the protection scope of the present invention.

In one embodiment, in the method 300, the determining a dedicated licensed frequency band, an unlicensed frequency band, or a non-dedicated licensed frequency band as the target frequency band for the to-be-sent information if the information type of the to-be-sent information is a monitoring type specifically includes the following steps.

Operation S316. Determine the unlicensed frequency band as the target frequency band for the to-be-sent information if the information type of the to-be-sent information is the monitoring type and the emergency degree of the to-be-sent information meets a first preset condition.

Operation S317. Determine the non-dedicated licensed frequency band as the target frequency band for the to-be-sent information if the information type of the to-be-sent information is the monitoring type and the emergency degree of the to-be-sent information meets a second preset condition.

Operation S318. Determine the dedicated licensed frequency band as the target frequency band for the to-be-sent information if the information type of the to-be-sent information is the monitoring type and the emergency degree of the to-be-sent information meets a third preset condition.

An emergency degree corresponding to the third preset condition is higher than an emergency degree corresponding to the first preset condition and an emergency degree corresponding to the second preset condition.

Information content of the to-be-sent information may be different; therefore, to-be-sent information of a same information type may have different emergency degrees in the power communications system, and an emergency degree of the information may be determined based on a preset condition.

For example, according to one embodiment, when the monitoring-type information is a difference between a cable temperature and an ambient temperature, the preset condition may be as follows: If information collected by a terminal device includes that the temperature difference between the cable temperature and the ambient temperature is less than 3 degrees Celsius, it may be considered that an emergency degree of the information is relatively low and meets the first preset condition, and the unlicensed frequency band with relatively low transmission reliability may be determined as a frequency band for sending the information; if information collected by a terminal device includes that the temperature difference between the cable temperature and the ambient temperature is greater than 3 degrees Celsius but less than 5 degrees Celsius, it may be considered that an emergency degree of the information is ordinary and meets the second preset condition, and the non-dedicated licensed frequency band with ordinary transmission reliability may be determined as a frequency band for sending the information; or if information collected by a terminal device includes that the temperature difference between the cable temperature and the ambient temperature is greater than 5 degrees Celsius, it may be considered that an emergency degree of the information is relatively high and meets the third preset condition, and the dedicated licensed frequency band with relatively high transmission reliability may be determined as a frequency band for sending the information.

It should be understood that the foregoing embodiment is merely an example for description, and a manner of determining a preset condition varies depending on information content or a currently used frequency band. For example, when information collected by a terminal device is current intensity information, different preset conditions may be set depending on current intensity. For another example, if currently available frequency bands include only a 230 MHz frequency band and a 2.4 GHz frequency band, preset conditions may be classified into two levels. Therefore, this embodiment of the present invention is not limited thereto. In the power communications system, any method that can be used to determine a target frequency band for to-be-sent information based on a preset condition shall fall within the protection scope of the present invention.

Therefore, according to the method for transmitting information in a power communications system provided in this embodiment of the present invention, the monitoring-type information of the relatively low emergency degree may be sent by using the unlicensed frequency band, the monitoring-type information of the ordinary emergency degree may be sent by using the non-dedicated licensed frequency band, and the monitoring-type information of the relatively high emergency degree may be sent by using the dedicated licensed frequency band. This can meet transmission requirements of monitoring-type information of different emergency degrees, and performance of the power communications system is improved.

Optionally, in the method 200, the dedicated licensed frequency band is a 230 MHz frequency band, the unlicensed frequency band is a 2.4 GHz frequency band or a 5 GHz frequency band, and the non-dedicated licensed frequency band is a 1.8 GHz frequency band.

Therefore, according to the method for transmitting information in a power communications system provided in this embodiment of the present invention, the target frequency band is determined from the at least two frequency bands based on the information type of the to-be-sent information, and the to-be-sent information is sent by using the target frequency band, so that a frequency band licensing status of the selected target frequency band can be adapted to the information type of the to-be-sent information, transmission requirements of information of different information types can be flexibly met, and the performance of the power communications system is improved.

FIG. 4 is a schematic flowchart of a method for transmitting information in a power communications system according to an embodiment of the present invention. The method shown in FIG. 4 may be performed by a transmit end device, and the transmit end device may be the electric brake 130, the sensor 140, or the smart meter 150 in FIG. 1, may be the power control center 110 in FIG. 1, or may be the forwarding device 120 in FIG. 1. As shown in FIG. 3, the method 400 includes the following operations.

Operation S410. Determine a target frequency band from at least two frequency bands based on an emergency degree of to-be-sent information and a correspondence between the emergency degree and a frequency band.

Operation S420. Send the to-be-sent information by using the target frequency band.

For example, if a power sensor collects information indicating that a cable temperature is the same as an ambient temperature, a power communications system may determine that the information is information of a relatively low emergency degree, and may further determine an unlicensed frequency band as a target frequency band for the information. If the power sensor collects information indicating that a cable temperature is 5 degrees Celsius higher than an ambient temperature, a power communications system may determine that the information is information of a relatively high emergency degree, and may further determine a licensed frequency band as a target frequency band for the information.

For another example, if a power control center sends, to an electric brake, information instructing to open the electric brake, the power communications system may determine that the information is information of a relatively high emergency degree, and may further determine a dedicated licensed frequency band as a target frequency band for the information. If a power control center sends, to a smart meter, information instructing to report power usage readings, the power communications system may determine that the information is information of a relatively low emergency degree, and may further determine a non-dedicated licensed frequency band as a target frequency band for the information.

It should be understood that the foregoing embodiment is merely an example for description, and this embodiment of the present invention is not limited thereto. Any power communications network that allows information to be transmitted by using at least two frequency bands and that can adapt a frequency band licensing status of a selected target frequency band to an emergency degree of to-be-sent information shall fall within the protection scope of the present invention.

Therefore, according to the method for transmitting information in a power communications system provided in this embodiment of the present invention, the target frequency band may be determined based on the emergency degree of the to-be-sent information, so that transmission requirements of information of different emergency degrees can be met, and performance of the power communications system is improved.

In one embodiment, the at least two frequency bands used by the power communications system in the method 400 include at least two of the dedicated licensed frequency band, the non-dedicated licensed frequency band, and the unlicensed frequency band.

In one embodiment, in the method 400, the determining a target frequency band from at least two frequency bands based on an emergency degree of to-be-sent information and a correspondence between the emergency degree and a frequency band specifically includes the following operations.

Operation S411. Determine the unlicensed frequency band as the target frequency band for the to-be-sent information if the emergency degree of the to-be-sent information meets a first preset condition.

Operation S412. Determine the non-dedicated licensed frequency band as the target frequency band for the to-be-sent information if the emergency degree of the to-be-sent information meets a second preset condition.

Operation S413. Determine the dedicated licensed frequency band as the target frequency band for the to-be-sent information if the emergency degree of the to-be-sent information meets a third preset condition.

An emergency degree corresponding to the third preset condition is higher than an emergency degree corresponding to the first preset condition and an emergency degree corresponding to the second preset condition.

Information content of the to-be-sent information may be different; therefore, the to-be-sent information may have different emergency degrees in the power communications system, and the emergency degree of the to-be-sent information may be determined based on a preset condition.

For example, according to one embodiment, when the to-be-sent information is a difference between a cable temperature and an ambient temperature, the preset condition may be as follows: If information collected by a terminal device includes that the temperature difference between the cable temperature and the ambient temperature is less than 3 degrees Celsius, it may be considered that an emergency degree of the information is relatively low and meets the first preset condition, and the unlicensed frequency band with relatively low transmission reliability may be determined as a frequency band for sending the information; if information collected by a terminal device includes that the temperature difference between the cable temperature and the ambient temperature is greater than 3 degrees Celsius but less than 5 degrees Celsius, it may be considered that an emergency degree of the information is ordinary and meets the second preset condition, and the non-dedicated licensed frequency band with ordinary transmission reliability may be determined as a frequency band for sending the information; or if information collected by a terminal device includes that the temperature difference between the cable temperature and the ambient temperature is greater than 5 degrees Celsius, it may be considered that an emergency degree of the information is relatively high and meets the third preset condition, and the dedicated licensed frequency band with relatively high transmission reliability may be determined as a frequency band for sending the information.

It should be understood that the foregoing embodiment is merely an example for description, and a manner of determining a preset condition varies depending on information content or a currently used frequency band. For example, when information collected by a terminal device is current intensity information, different preset conditions may be set depending on current intensity. For another example, if currently available frequency bands include only a 230 MHz frequency band and a 2.4 GHz frequency band, preset conditions may be classified into two levels. Therefore, this embodiment of the present invention is not limited thereto. In the power communications system, any method that can be used to determine a target frequency band for to-be-sent information based on a preset condition shall fall within the protection scope of the present invention.

Therefore, according to the method for transmitting information in a power communications system provided in this embodiment of the present invention, the information of a relatively low emergency degree may be sent by using the unlicensed frequency band, the information of the ordinary emergency degree may be sent by using the non-dedicated licensed frequency band, and the information of a relatively high emergency degree may be sent by using the dedicated licensed frequency band, so that transmission requirements of information of different emergency degrees can be met, and performance of the power communications system is improved.

Optionally, in the method 400, the dedicated licensed frequency band is a 230 MHz frequency band, the unlicensed frequency band is a 2.4 GHz frequency band or a 5 GHz frequency band, and the non-dedicated licensed frequency band is a 1.8 GHz frequency band.

Therefore, according to the method for transmitting information in a power communications system provided in this embodiment of the present invention, the target frequency band is determined from the at least two frequency bands based on the emergency degree of the to-be-sent information and the correspondence between the emergency degree and the frequency band, and the to-be-sent information is sent by using the target frequency band, so that a frequency band licensing status of the selected target frequency band can be adapted to the emergency degree of the to-be-sent information, transmission requirements of information of different information types can be flexibly met, and the performance of the power communications system is improved.

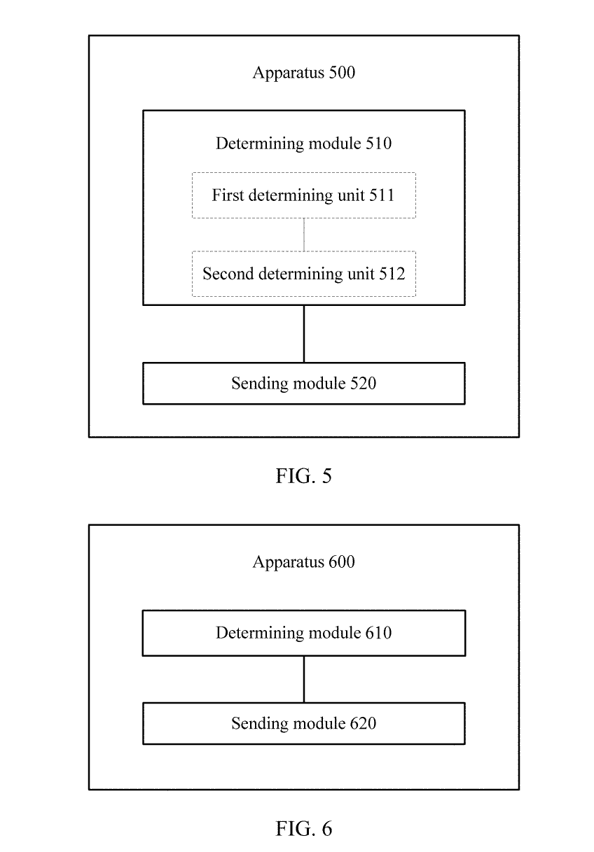

With reference to FIG. 3 and FIG. 4, the foregoing details the method for transmitting information in a power communications system according to the embodiments of the present invention. With reference to FIG. 5 and FIG. 6, the following details an apparatus for transmitting information in a power communications system according to the embodiments of the present invention.

FIG. 5 is a schematic block diagram of an apparatus for transmitting information in a power communications system according to an embodiment of the present invention. As shown in FIG. 5, the apparatus 500 includes:

a determining module 510, configured to determine a target frequency band from at least two frequency bands based on an information type of to-be-sent information and a correspondence between the information type and at least one of the at least two frequency bands; and

a sending module 520, configured to send the to-be-sent information by using the target frequency band determined by the determining module 510.

The apparatus 500 for transmitting information in a power communications system provided in this embodiment of the present invention determines the target frequency band from the at least two frequency bands based on the information type of the to-be-sent information, and sends the to-be-sent information by using the target frequency band, so that a frequency band licensing status of the selected target frequency band can be adapted to the information type of the to-be-sent information, transmission requirements of information of different information types can be flexibly met, and performance of a power communications system is improved.

In one embodiment, the determining module 510 includes:

a first determining unit 511, configured to determine a candidate target frequency band from the at least two frequency bands based on the information type of the to-be-sent information and the correspondence between the information type and at least one of the at least two frequency bands; and

a second determining unit 512, configured to determine a target frequency band from the candidate target frequency band based on an emergency degree of the to-be-sent information.

The apparatus for transmitting information in a power communications system provided in this embodiment of the present invention may determine the target frequency band based on the emergency degree of the to-be-sent information, so that transmission requirements of information of different emergency degrees can be met, and the performance of the power communications system is improved.

In one embodiment, the at least two frequency bands determined by the apparatus 500 include at least two of a dedicated licensed frequency band, a non-dedicated licensed frequency band, and an unlicensed frequency band that are used by the power communications system.

In one embodiment, the information type of the to-be-transmitted information includes a control type, a monitoring type, or a metering type.

In one embodiment, the determining module 510 is specifically configured to:

determine the dedicated licensed frequency band as the target frequency band for the to-be-sent information if the information type of the to-be-sent information is the control type;

determine the dedicated licensed frequency band, the unlicensed frequency band, or the non-dedicated licensed frequency band as the target frequency band for the to-be-sent information if the information type of the to-be-sent information is the monitoring type; or determine the unlicensed frequency band or the non-dedicated licensed frequency band as the target frequency band for the to-be-sent information if the information type of the to-be-sent information is the metering type.

Therefore, the apparatus for transmitting information in a power communications system provided in this embodiment of the present invention may send control-type information by using the dedicated licensed frequency band, send monitoring-type information by using the dedicated licensed frequency band, the unlicensed frequency band, or the non-dedicated licensed frequency band, and send metering-type information by using the unlicensed frequency band or the non-dedicated licensed frequency band. Therefore, a transmission requirement of the control-type information for relatively high information QoS or channel reliability can be met, a transmission requirement of the metering-type information for relatively large bandwidth but relatively low information QoS or channel reliability can be met, and performance of the power communications system is improved.

In one embodiment, when the dedicated licensed frequency band, the unlicensed frequency band, or the non-dedicated licensed frequency band is determined as the target frequency band for the to-be-sent information if the information type of the to-be-sent information is the monitoring type, the determining module 510 is specifically configured to:

determine the unlicensed frequency band as the target frequency band for the to-be-sent information if the information type of the to-be-sent information is the monitoring type and the emergency degree of the to-be-sent information meets a first preset condition;

determine the non-dedicated licensed frequency band as the target frequency band for the to-be-sent information if the information type of the to-be-sent information is the monitoring type and the emergency degree of the to-be-sent information meets a second preset condition; or determine the dedicated licensed frequency band as the target frequency band for the to-be-sent information if the information type of the to-be-sent information is the monitoring type and the emergency degree of the to-be-sent information meets a third preset condition.

An emergency degree corresponding to the third preset condition is higher than an emergency degree corresponding to the first preset condition and an emergency degree corresponding to the second preset condition.

Therefore, the apparatus for transmitting information in a power communications system provided in this embodiment of the present invention may send monitoring-type information of a relatively low emergency degree by using the unlicensed frequency band, send monitoring-type information of an ordinary emergency degree by using the non-dedicated licensed frequency band, and send monitoring-type information of a relatively high emergency degree by using the dedicated licensed frequency band, so that transmission requirements of monitoring-type information of different emergency degrees can be met, and the performance of the power communications system is improved.

In one embodiment, the dedicated licensed frequency band used by the apparatus 500 is a 230 MHz frequency band, the unlicensed frequency band used by the apparatus 500 is a 2.4 GHz frequency band and/or a 5 GHz frequency band, and the non-dedicated licensed frequency band used by the apparatus 500 is a 1.8 GHz frequency band.

The apparatus 500 for transmitting information according to this embodiment of the present invention may correspond to the transmit end device in the method 300 in the embodiments of the present invention. In addition, the foregoing and other operations and/or functions of the modules in the apparatus 500 for transmitting information in FIG. 5 are used to implement procedures corresponding to steps in the method 300 in FIG. 3. For brevity, details are not described herein again.

The apparatus for transmitting information provided in this embodiment of the present invention determines the target frequency band from the at least two frequency bands based on the information type of the to-be-sent information, and sends the to-be-sent information by using the target frequency band, so that the frequency band licensing status of the selected target frequency band can be adapted to the information type of the to-be-sent information, transmission requirements of information of different information types can be flexibly met, and the performance of the power communications system is improved.

FIG. 6 is a schematic block diagram of an apparatus for transmitting information in a power communications system according to an embodiment of the present invention. As shown in FIG. 6, the apparatus 600 includes:

a determining module 610, configured to determine a target frequency band from at least two frequency bands based on an emergency degree of to-be-sent information and a correspondence between the emergency degree and a frequency band; and

a sending module 620, configured to send the to-be-sent information by using the target frequency band determined by the determining module 610.

The apparatus 600 for transmitting information in a power communications system provided in this embodiment of the present invention determines the target frequency band from the at least two frequency bands based on the emergency degree of the to-be-sent information and the correspondence between the emergency degree and the frequency band, and sends the to-be-sent information by using the target frequency band, so that a frequency band licensing status of the selected target frequency band can be adapted to the emergency degree of the to-be-sent information, transmission requirements of information of different emergency degrees can be flexibly met, and performance of a power communications system is improved.

In one embodiment, the at least two frequency bands used by the apparatus 600 include at least two of a dedicated licensed frequency band, a non-dedicated licensed frequency band, and an unlicensed frequency band that are used by the power communications system.

In one embodiment, the determining module 610 is specifically configured to:

determine the unlicensed frequency band as the target frequency band for the to-be-sent information if the emergency degree of the to-be-sent information meets a first preset condition;

determine the non-dedicated licensed frequency band as the target frequency band for the to-be-sent information if the emergency degree of the to-be-sent information meets a second preset condition; or

determine the dedicated licensed frequency band as the target frequency band for the to-be-sent information if the emergency degree of the to-be-sent information meets a third preset condition.

An emergency degree corresponding to the third preset condition is higher than an emergency degree corresponding to the first preset condition and an emergency degree corresponding to the second preset condition.

Therefore, the apparatus for transmitting information in a power communications system provided in this embodiment of the present invention may send information of a relatively low emergency degree by using the unlicensed frequency band, send information of an ordinary emergency degree by using the non-dedicated licensed frequency band, and send information of a relatively high emergency degree by using the dedicated licensed frequency band, so that transmission requirements of information of different emergency degrees can be met, and the performance of the power communications system is improved.

In one embodiment, the dedicated licensed frequency band used by the apparatus 600 is a 230 MHz frequency band, the unlicensed frequency band used by the apparatus 600 is a 2.4 GHz frequency band and/or a 5 GHz frequency band, and the non-dedicated licensed frequency band used by the apparatus 600 is a 1.8 GHz frequency band.

The apparatus 600 for transmitting information according to this embodiment of the present invention may correspond to the transmit end device in the method 400 in the embodiments of the present invention. In addition, the foregoing and other operations and/or functions of the modules in the apparatus 600 for transmitting information in FIG. 6 are used to implement procedures corresponding to steps in the method 400 in FIG. 4. For brevity, details are not described herein again.

The apparatus for transmitting information provided in this embodiment of the present invention determines the target frequency band from the at least two frequency bands based on the information type of the to-be-sent information, and sends the to-be-sent information by using the target frequency band, so that the frequency band licensing status of the selected target frequency band can be adapted to the information type of the to-be-sent information, transmission requirements of information of different information types can be flexibly met, and the performance of the power communications system is improved.

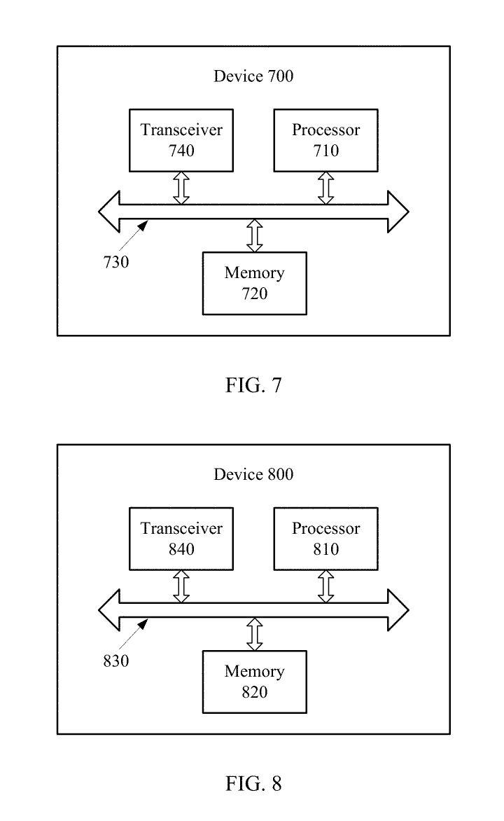

With reference to FIG. 3 to FIG. 6, the foregoing details the method and the apparatus for transmitting information in a power communications system according to the embodiments of the present invention. With reference to FIG. 7 and FIG. 8, the following details a device for transmitting information in a power communications system according to the embodiments of the present invention.

FIG. 7 is a schematic block diagram of a device for transmitting information in a power communications system according to an embodiment of the present invention. As shown in FIG. 7, the device 700 includes a processor 710, a memory 720, a bus system 730, and a transceiver 740. The processor 710, the memory 720, and the transceiver 740 are connected by using the bus system 730, the memory 720 is configured to store an instruction, and the processor 710 is configured to execute the instruction stored in the memory 720, so as to control the transceiver 740 to receive or send a signal.

The processor 710 is configured to determine a target frequency band from at least two frequency bands based on an information type of to-be-sent information and a correspondence between the information type and at least one of the at least two frequency bands. The transceiver 740 is configured to send the to-be-sent information by using the target frequency band determined by the processor 710.

Therefore, the device for transmitting information provided in this embodiment of the present invention determines the target frequency band from the at least two frequency bands based on the information type of the to-be-sent information, and sends the to-be-sent information by using the target frequency band, so that a frequency band licensing status of the selected target frequency band can be adapted to the information type of the to-be-sent information, transmission requirements of information of different information types can be flexibly met, and performance of a power communications system is improved.

It should be understood that in this embodiment of the present invention, the processor 710 may be a central processing unit (CPU), or the processor 710 may be another general purpose processor, a digital signal processor (DSP), an application-specific integrated circuit (ASIC), a field programmable gate array (FPGA) or another programmable logic device, a discrete gate or transistor logic device, a discrete hardware component, or the like. The general purpose processor may be a microprocessor, or the processor may be any conventional processor, or the like.

The memory 720 may include a read-only memory and a random access memory, and provide instructions and data for the processor 710. A part of the memory 720 may further include a non-volatile random access memory. For example, the memory 720 may further store device type information.

The bus system 730 may include a data bus, and may further include a power bus, a control bus, a status signal bus, and the like. However, for clear description, various buses are marked as the bus system 730 in the figure.

During implementation, operations of the foregoing methods may be implemented by using an integrated logical circuit of hardware in the processor 710, or by using a software instruction. The steps of the methods disclosed with reference to the embodiments of the present invention may be directly implemented by using a hardware processor, or may be implemented by using a combination of hardware and a software module in the processor. The software module may be located in a random access memory, a flash memory, a read-only memory, a programmable read-only memory, an electrical erasable programmable memory, a register, or another mature storage medium in the art. The storage medium is located in the memory 720. The processor 710 reads information in the memory 720 and completes the steps of the foregoing methods in combination with hardware of the processor 710. To avoid repetition, no detailed description is given herein again.

Optionally, in an embodiment, the processor 710 is configured to: determine a candidate target frequency band from the at least two frequency bands based on the information type of the to-be-sent information and the correspondence between the information type and at least one of the at least two frequency bands; and determine a target frequency band from the candidate target frequency band based on an emergency degree of the to-be-sent information.

The device for transmitting information in a power communications system provided in this embodiment of the present invention may determine the target frequency band based on the emergency degree of the to-be-sent information, so that transmission requirements of information of different emergency degrees can be met, and the performance of the power communications system is improved.

Optionally, in an embodiment, the at least two frequency bands determined by the processor 710 include at least two of a dedicated licensed frequency band, a non-dedicated licensed frequency band, and an unlicensed frequency band that are used by the power communications system.

Optionally, in an embodiment, types of information transmitted by the transceiver 740 include a control type, a monitoring type, or a metering type.

Optionally, in an embodiment, the processor 710 is specifically configured to:

determine the dedicated licensed frequency band as the target frequency band for the to-be-sent information if the information type of the to-be-sent information is the control type;

determine the dedicated licensed frequency band, the unlicensed frequency band, or the non-dedicated licensed frequency band as the target frequency band for the to-be-sent information if the information type of the to-be-sent information is the monitoring type; or

determine the unlicensed frequency band or the non-dedicated licensed frequency band as the target frequency band for the to-be-sent information if the information type of the to-be-sent information is the metering type.

Therefore, the device for transmitting information in a power communications system provided in this embodiment of the present invention may send control-type information by using the dedicated licensed frequency band, send monitoring-type information by using the dedicated licensed frequency band, the unlicensed frequency band, or the non-dedicated licensed frequency band, and send metering-type information by using the unlicensed frequency band or the non-dedicated licensed frequency band, so that a transmission requirement of the control-type information for relatively high information quality of service QoS or channel reliability can be met, a transmission requirement of the metering-type information for relatively large bandwidth but relatively low information QoS or channel reliability can be met, and the performance of the power communications system is improved.

Optionally, in an embodiment, if the information type of the to-be-sent information is a monitoring type, and a dedicated licensed frequency band, an unlicensed frequency band, or a non-dedicated licensed frequency band is determined as the target frequency band for the to-be-sent information, the processor 710 is specifically configured to:

determine the unlicensed frequency band as the target frequency band for the to-be-sent information if the information type of the to-be-sent information is the monitoring type and the emergency degree of the to-be-sent information meets a first preset condition;

determine the non-dedicated licensed frequency band as the target frequency band for the to-be-sent information if the information type of the to-be-sent information is the monitoring type and the emergency degree of the to-be-sent information meets a second preset condition; or

determine the dedicated licensed frequency band as the target frequency band for the to-be-sent information if the information type of the to-be-sent information is the monitoring type and the emergency degree of the to-be-sent information meets a third preset condition.

An emergency degree corresponding to the third preset condition is higher than an emergency degree corresponding to the first preset condition and an emergency degree corresponding to the second preset condition.

Therefore, the device for transmitting information in a power communications system provided in this embodiment of the present invention may send monitoring-type information of a relatively low emergency degree by using the unlicensed frequency band, send monitoring-type information of an ordinary emergency degree by using the non-dedicated licensed frequency band, and send monitoring-type information of a relatively high emergency degree by using the dedicated licensed frequency band, so that transmission requirements of monitoring-type information of different emergency degrees can be met, and the performance of the power communications system is improved.

Optionally, in an embodiment, a dedicated licensed frequency band used by the device 700 is a 230 MHz frequency band, an unlicensed frequency band used by the device 700 is a 2.4 GHz frequency band or a 5 GHz frequency band, and a non-dedicated licensed frequency band used by the device 700 is a 1.8 GHz frequency band.

The device 700 for transmitting information in a power communications system according to this embodiment of the present invention may correspond to the transmit end device in the method 300 in the embodiments of the present invention. In addition, the foregoing and other operations and/or functions of the modules in the device 700 for transmitting information in FIG. 7 are used to implement procedures corresponding to steps in the method 300 in FIG. 3. For brevity, details are not described herein again.

The device for transmitting information in a power communications system provided in this embodiment of the present invention determines the target frequency band from the at least two frequency bands based on the information type of the to-be-sent information, and sends the to-be-sent information by using the target frequency band, so that the frequency band licensing status of the selected target frequency band can be adapted to the information type of the to-be-sent information, transmission requirements of information of different information types can be flexibly met, and the performance of the power communications system is improved.

FIG. 8 is a schematic block diagram of a device for transmitting information in a power communications system according to an embodiment of the present invention. As shown in FIG. 8, the device 800 includes a processor 810, a memory 820, a bus system 830, and a transceiver 840. The processor 810, the memory 820, and the transceiver 840 are connected by using the bus system 830, the memory 820 is configured to store an instruction, and the processor 810 is configured to execute the instruction stored in the memory 820, so as to control the transceiver 840 to receive or send a signal.

The processor 810 is configured to determine a target frequency band from at least two frequency bands based on an emergency degree of to-be-sent information and a correspondence between the emergency degree and a frequency band. The transceiver 840 is configured to send the to-be-sent information by using the target frequency band determined by the processor 810.

Therefore, the device for transmitting information provided in this embodiment of the present invention determines the target frequency band from the at least two frequency bands based on the emergency degree of the to-be-sent information and the correspondence between the emergency degree and the frequency band, and sends the to-be-sent information by using the target frequency band, so that a frequency band licensing status of the selected target frequency band can be adapted to the emergency degree of the to-be-sent information, transmission requirements of information of different emergency degrees can be flexibly met, and performance of a power communications system is improved.

It should be understood that in this embodiment of the present invention, the processor 810 may be a CPU, or the processor 810 may be another general purpose processor, a digital signal processor (DSP), an application-specific integrated circuit (ASIC), a field programmable gate array (FPGA) or another programmable logic device, a discrete gate or transistor logic device, a discrete hardware component, or the like. The general purpose processor may be a microprocessor, or the processor may be any conventional processor, or the like.

The memory 820 may include a read-only memory and a random access memory, and provide instructions and data for the processor 810. A part of the memory 820 may further include a non-volatile random access memory. For example, the memory 820 may further store device type information.

The bus system 830 may include a data bus, and may further include a power bus, a control bus, a status signal bus, and the like. However, for clear description, various buses are marked as the bus system 830 in the figure.

During implementation, operations of the foregoing methods may be implemented by using an integrated logical circuit of hardware in the processor 810, or by using a software instruction. The steps of the methods disclosed with reference to the embodiments of the present invention may be directly implemented by using a hardware processor, or may be implemented by using a combination of hardware and a software module in the processor. The software module may be located in a random access memory, a flash memory, a read-only memory, a programmable read-only memory, an electrical erasable programmable memory, a register, or another mature storage medium in the art. The storage medium is located in the memory 820. The processor 810 reads information in the memory 820 and completes the steps of the foregoing methods in combination with hardware of the processor 810. To avoid repetition, no detailed description is given herein again.

Optionally, in an embodiment, the at least two frequency bands used by the device 800 include at least two of a dedicated licensed frequency band, a non-dedicated licensed frequency band, and an unlicensed frequency band that are used by the power communications system.

Optionally, in an embodiment, the processor 810 invokes an instruction stored in the memory, so as to specifically:

determine the unlicensed frequency band as the target frequency band for the to-be-sent information if the emergency degree of the to-be-sent information meets a first preset condition;

determine the non-dedicated licensed frequency band as the target frequency band for the to-be-sent information if the emergency degree of the to-be-sent information meets a second preset condition; or

determine the dedicated licensed frequency band as the target frequency band for the to-be-sent information if the emergency degree of the to-be-sent information meets a third preset condition.

An emergency degree corresponding to the third preset condition is higher than an emergency degree corresponding to the first preset condition and an emergency degree corresponding to the second preset condition.

Therefore, the device for transmitting information in a power communications system provided in this embodiment of the present invention may send information of a relatively low emergency degree by using the unlicensed frequency band, send information of an ordinary emergency degree by using the non-dedicated licensed frequency band, and send information of a relatively high emergency degree by using the dedicated licensed frequency band, so that transmission requirements of information of different emergency degrees can be met, and the performance of the power communications system is improved.

Optionally, in an embodiment, a dedicated licensed frequency band used by the device 800 is a 230 MHz frequency band, an unlicensed frequency band used by the device 800 is a 2.4 GHz frequency band or a 5 GHz frequency band, and a non-dedicated licensed frequency band used by the device 800 is a 1.8 GHz frequency band.

The device 800 for transmitting information in a power communications system according to this embodiment of the present invention may correspond to the transmit end device in the method 400 in the embodiments of the present invention. In addition, the foregoing and other operations and/or functions of the modules in the device 800 for transmitting information in FIG. 8 are used to implement procedures corresponding to steps in the method 400 in FIG. 4. For brevity, details are not described herein again.

The device for transmitting information in a power communications system provided in this embodiment of the present invention determines the target frequency band from the at least two frequency bands based on the emergency degree of the to-be-sent information and the correspondence between the emergency degree and the frequency band, and sends the to-be-sent information by using the target frequency band, so that the frequency band licensing status of the selected target frequency band can be adapted to the emergency degree of the to-be-sent information, transmission requirements of information of different emergency degrees can be flexibly met, and the performance of the power communications system is improved.

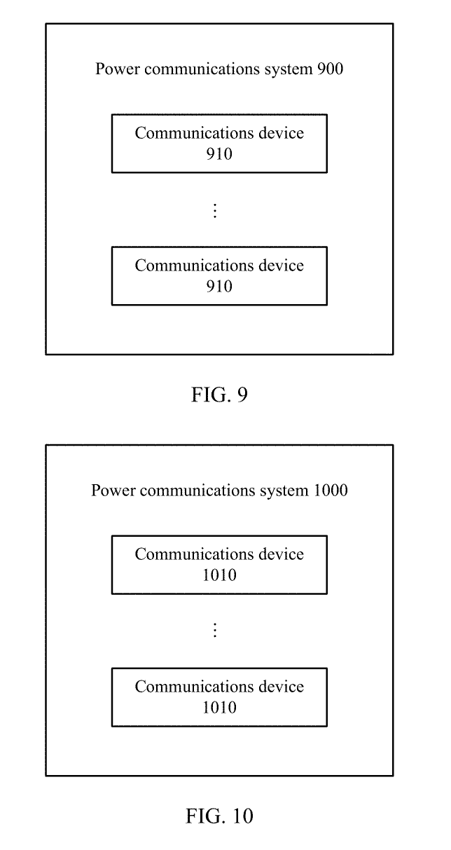

With reference to FIG. 9 and FIG. 10, the following details a power communications system according to the embodiments of the present invention.

FIG. 9 is a schematic block diagram of a power communications system according to an embodiment of the present invention. As shown in FIG. 9, the power communications system 900 uses at least two frequency bands for wireless communication, frequency band licensing statuses of the at least two frequency bands are different, the power communications system 900 includes a plurality of communications devices 910, and the plurality of communications devices 910 perform power communication by sending and receiving information. There is a correspondence between an information type of the information sent by the communications device 910 and the frequency band. When performing the power communication, the communications device 910 sends the information by using a frequency band corresponding to the information type of the information.

It should be understood that FIG. 9 shows only two communications devices 910, but this embodiment of the present invention is not limited thereto. The power communications system 900 in this embodiment of the present invention may further include another quantity of communications devices 910.

The communications device 910 that is included in the power communications system 900 provided in this embodiment of the present invention sends the information on the corresponding frequency band based on the correspondence between the information type and at least one of the at least two frequency bands. Specifically, in the system 900, some communications devices 910 need to send a plurality of types of information. For these communications devices, corresponding modules in the foregoing embodiments may be implemented in the devices in a software or hardware manner, so as to determine, based on information types of different to-be-sent information, frequency bands corresponding to the information types, and send the information on the frequency bands. A specific implementation is described in the foregoing embodiments, and details are not described herein again.

In addition, in the system 900, some communications devices 910 may send only one type of information. For example, some smart meters may send only metering-type information, while some sensors may send only monitoring-type information. It can be understood that these communications devices may be configured in the foregoing manner, that is, corresponding modules in the foregoing embodiments are configured in the devices, so that the devices can determine a corresponding frequency band based on the information type of the information and send the information. Alternatively, information sending manner of the foregoing devices may be directly configured, in a preset manner or the like, as sending information on a frequency band corresponding to an information type of the information sent by the devices. The second configuration manner can simplify the communications device and improve device adaptivity and system compatibility.

Optionally, in an embodiment, when the communications device 910 sends the information by using the frequency band corresponding to the information type of the to-be-sent information, the method further includes:

when the information type of the to-be-sent information corresponds to at least two frequency bands, determining a target frequency band from the at least two frequency bands based on an emergency degree of the to-be-sent information, and sending the to-be-sent information by using the target frequency band.

The power communications system 900 provided in this embodiment of the present invention may determine the target frequency band based on the emergency degree of the to-be-sent information, so that transmission requirements of information of different emergency degrees can be met, and performance of the power communications system is improved.

Optionally, in an embodiment, the at least two frequency bands include at least two of a dedicated licensed frequency band, a non-dedicated licensed frequency band, and an unlicensed frequency band that are used by the power communications system 900.

The information type of the to-be-sent information includes a control type, a monitoring type, or a metering type.

That when performing the power communication, the communications device 910 sends the to-be-sent information by using a frequency band corresponding to the information type of the to-be-sent information specifically includes:

sending, by the communications device, the to-be-sent information by using the dedicated licensed frequency band if the information type is the control type;

sending, by the communications device, the to-be-sent information by using the dedicated licensed frequency band, the unlicensed frequency band, or the non-dedicated licensed frequency band if the information type is the monitoring type; or

sending, by the communications device, the to-be-sent information by using the unlicensed frequency band or the non-dedicated licensed frequency band if the information type is the metering type.

Therefore, the power communications system 900 provided in this embodiment of the present invention may send control-type information by using the dedicated licensed frequency band, send monitoring-type information by using the dedicated licensed frequency band, the unlicensed frequency band, or the non-dedicated licensed frequency band, and send metering-type information by using the unlicensed frequency band or the non-dedicated licensed frequency band, so that a transmission requirement of the control-type information for relatively high information quality of service QoS or channel reliability can be met, a transmission requirement of the metering-type information for relatively large bandwidth but relatively low information QoS or channel reliability can be met, and the performance of the power communications system is improved.

Optionally, in an embodiment, the sending, by the communications device, the to-be-sent information by using the dedicated licensed frequency band, the unlicensed frequency band, or the non-dedicated licensed frequency band if the information type of the to-be-sent information is the monitoring type specifically includes:

if the information type of the to-be-sent information is the monitoring type and the emergency degree of the to-be-sent information meets a first preset condition, determining the unlicensed frequency band as the target frequency band for the to-be-sent information, and sending the to-be-sent information by using the target frequency band;

if the information type of the to-be-sent information is the monitoring type and the emergency degree of the to-be-sent information meets a second preset condition, determining the non-dedicated licensed frequency band as the target frequency band for the to-be-sent information, and sending the to-be-sent information by using the target frequency band; or if the information type of the to-be-sent information is the monitoring type and the emergency degree of the to-be-sent information meets a third preset condition, determining the dedicated licensed frequency band as the target frequency band for the to-be-sent information, and sending the to-be-sent information by using the target frequency band.

An emergency degree corresponding to the third preset condition is higher than an emergency degree corresponding to the first preset condition and an emergency degree corresponding to the second preset condition.

Therefore, the power communications system 900 provided in this embodiment of the present invention may send monitoring-type information of a relatively low emergency degree by using the unlicensed frequency band, send monitoring-type information of an ordinary emergency degree by using the non-dedicated licensed frequency band, and send monitoring-type information of a relatively high emergency degree by using the dedicated licensed frequency band, so that transmission requirements of monitoring-type information of different emergency degrees can be met, and the performance of the power communications system is improved.

Optionally, in an embodiment, the dedicated licensed frequency band used by the power communications system is a 230 MHz frequency band, the unlicensed frequency band used by the power communications system is a 2.4 GHz frequency band or a 5 GHz frequency band, and the non-dedicated licensed frequency band used by the power communications system is a 1.8 GHz frequency band.

The power communications system 900 and the communications device 910 in the power communications system 900 according to this embodiment of the present invention may correspond to the transmit end device in the method in the embodiments of the present invention. In addition, the foregoing and other operations and/or functions of the communications device 910 for transmitting information in FIG. 9 are used to implement procedures corresponding to steps in the method 300 in FIG. 3. For brevity, details are not described herein again.

The power communications system 900 provided in this embodiment of the present invention determines the target frequency band from the at least two frequency bands based on the information type of the to-be-sent information, and sends the to-be-sent information by using the target frequency band, so that the frequency band licensing status of the selected target frequency band can be adapted to the information type or the emergency degree of the to-be-sent information, transmission requirements of information of different information types can be flexibly met, and the performance of the power communications system is improved.

FIG. 10 is another schematic block diagram of a power communications system according to an embodiment of the present invention. As shown in FIG. 10, the power communications system 1000 uses at least two frequency bands for wireless communication, frequency band licensing statuses of the at least two frequency bands are different, the power communications system 1000 includes a plurality of communications devices 1010, and the plurality of communications devices perform power communication by sending and receiving information. There is a correspondence between an emergency degree of the information sent by the communications device and the frequency band. When performing the power communication, the communications device sends the information by using a frequency band corresponding to the emergency degree of the information.

It should be understood that FIG. 10 shows only two communications devices 1010, but this embodiment of the present invention is not limited thereto. The power communications system 1000 in this embodiment of the present invention may further include another quantity of communications devices 1010.

The communications device 1010 that is included in the power communications system 1000 provided in this embodiment of the present invention sends corresponding information on a corresponding frequency band based on the correspondence between the emergency degree of the information and the frequency band. Specifically, in the system 1000, some communications devices 1010 need to send information of a plurality of emergency degrees. For these communications devices, corresponding modules in the foregoing embodiments may be implemented in the devices in a software or hardware manner, so as to determine, based on information types of different to-be-sent information, frequency bands corresponding to the emergency degrees of the information, and send the information on the corresponding frequency bands. A specific implementation is described in the foregoing embodiments, and details are not described herein again.

In addition, in the system 1000, emergency degrees of information sent by some communications devices 1010 are different. For example, some sensors may send monitoring-type information about a difference between a cable temperature and an ambient temperature, and information about different temperature differences corresponds to different emergency degrees. It can be understood that these communications devices may be configured in the foregoing manner, that is, corresponding modules in the foregoing embodiments are configured in the devices, so that the devices can determine a corresponding frequency band based on an emergency degree of information and send the information.

Optionally, in an embodiment, when the communications device 1010 sends the information by using the frequency band corresponding to the emergency degree of the to-be-sent information, the method further includes:

when the information type of the to-be-sent information corresponds to at least two frequency bands, determining a target frequency band from the at least two frequency bands based on the emergency degree of the to-be-sent information, and sending the to-be-sent information by using the target frequency band.

The power communications system 1000 provided in this embodiment of the present invention may determine the target frequency band based on the emergency degree of the to-be-sent information, so that transmission requirements of information of different emergency degrees can be met, and the performance of the power communications system is improved.

Optionally, in an embodiment, the at least two frequency bands include at least two of a dedicated licensed frequency band, a non-dedicated licensed frequency band, and an unlicensed frequency band that are used by the power communications system 1000.

Optionally, in an embodiment, the unlicensed frequency band is determined as the target frequency band for the to-be-sent information if the emergency degree of the to-be-sent information meets a first preset condition.

The non-dedicated licensed frequency band is determined as the target frequency band for the to-be-sent information if the emergency degree of the to-be-sent information meets a second preset condition.

The dedicated licensed frequency band is determined as the target frequency band for the to-be-sent information if the emergency degree of the to-be-sent information meets a third preset condition.

An emergency degree corresponding to the third preset condition is higher than an emergency degree corresponding to the first preset condition and an emergency degree corresponding to the second preset condition.

Therefore, the power communications system 1000 provided in this embodiment of the present invention may send information of a relatively low emergency degree by using the unlicensed frequency band, send information of an ordinary emergency degree by using the non-dedicated licensed frequency band, and send information of a relatively high emergency degree by using the dedicated licensed frequency band, so that transmission requirements of monitoring-type information of different emergency degrees can be met, and performance of the power communications system is improved.

Optionally, in an embodiment, the dedicated licensed frequency band used by the power communications system is a 230 MHz frequency band, the unlicensed frequency band used by the power communications system is a 2.4 GHz frequency band or a 5 GHz frequency band, and the non-dedicated licensed frequency band used by the power communications system is a 1.8 GHz frequency band.

The power communications system 1000 and the communications device 1010 in the power communications system 1000 according to this embodiment of the present invention may correspond to the transmit end device in the method in the embodiments of the present invention. In addition, the foregoing and other operations and/or functions of the communications device 1010 for transmitting information in FIG. 10 are used to implement procedures corresponding to steps in the method 400 in FIG. 4. For brevity, details are not described herein again.

The power communications system 1000 provided in this embodiment of the present invention determines the target frequency band from the at least two frequency bands based on the emergency degree of the to-be-sent information, and sends the to-be-sent information by using the target frequency band, so that the frequency band licensing status of the selected target frequency band can be adapted to the emergency degree of the to-be-sent information, transmission requirements of information of different emergency degrees can be flexibly met, and the performance of the power communications system is improved.

A person of ordinary skill in the art may be aware that, in combination with the examples described in the embodiments disclosed in this specification, units and algorithm steps may be implemented by electronic hardware, computer software, or a combination thereof. To clearly describe the interchangeability between the hardware and the software, the foregoing has generally described compositions and steps of each example according to functions. Whether the functions are performed by hardware or software depends on particular applications and design constraint conditions of the technical solutions. A person skilled in the art may use different methods to implement the described functions for each particular application, but it should not be considered that the implementation goes beyond the scope of the present invention.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not be performed. In addition, the displayed or discussed mutual couplings or direct couplings or communication connections may be implemented through some interfaces, indirect couplings or communication connections between the apparatuses or units, or electrical connections, mechanical connections, or connections in other forms.

The units described as separate parts may or may not be physically separate, and parts displayed as units may or may not be physical units, may be located in one position, or may be distributed on a plurality of network units. A part or all of the units may be selected depending on actual needs to achieve the objectives of the solutions of the embodiments of the present invention.

In addition, functional units in the embodiments of the present invention may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present invention essentially, or the part contributing to the prior art, or all or a part of the technical solutions may be implemented in the form of a software product. The computer software product is stored in a storage medium and includes several instructions for instructing a computer device (which may be a personal computer, a server, a network device, or the like) to perform all or a part of the steps of the methods described in the embodiments of the present invention. The foregoing storage medium includes any medium that can store program code, such as a USB flash drive, a removable hard disk, a read-only memory (ROM, Read-Only Memory), a random access memory (RAM, Random Access Memory), a magnetic disk, or an optical disc.

The foregoing descriptions are merely specific embodiments of the present invention, but are not intended to limit the protection scope of the present invention. Any modification or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A method for transmitting information in a power communications system, wherein the method is applied to a power communications system that uses at least two frequency bands for wireless communication, frequency band licensing statuses of the at least two frequency bands are different, and the method comprises:
determining a target frequency band from the at least two frequency bands based on an information type of information to be sent and a correspondence between the information type and each of the least two frequency bands; and
sending the to-be-sent information using the target frequency band.

2. The method according to claim 1, wherein the determining a target frequency band from the at least two frequency bands based on an information type of information to be sent and a correspondence between the information type and each of the at least two frequency bands comprises:
determining a candidate target frequency band from the at least two frequency bands based on the information type of the to-be-sent information and the correspondence between the information type and each of the at least two frequency bands; and
determining a target frequency band from the candidate target frequency band based on an emergency degree of the to-be-sent information.

3. The method according to claim 1, wherein the at least two frequency bands comprise at least two of a dedicated licensed frequency band, a non-dedicated licensed frequency band, and an unlicensed frequency band that are used by the power communications system.

4. The method according to claim 1, wherein the information type comprises a control type, a monitoring type, or a metering type.

5. The method according to claim 4, wherein the determining a target frequency band from the at least two frequency bands based on an information type of information to be sent and a correspondence between the information type and each of the at least two frequency bands comprises:
determining the dedicated licensed frequency band as the target frequency band for the to-be-sent information if the information type of the to-be-sent information is the control type;
determining the dedicated licensed frequency band, the unlicensed frequency band, or the non-dedicated licensed frequency band as the target frequency band for the to-be-sent information if the information type of the to-be-sent information is the monitoring type; or
determining the unlicensed frequency band or the non-dedicated licensed frequency band as the target frequency band for the to-be-sent information if the information type of the to-be-sent information is the metering type.

6. The method according to claim 5, wherein the determining the dedicated licensed frequency band, the unlicensed frequency band, or the non-dedicated licensed frequency band as the target frequency band for the to-be-sent information if the information type of the to-be-sent information is the monitoring type comprises:
determining the unlicensed frequency band as the target frequency band for the to-be-sent information if the information type of the to-be-sent information is the monitoring type and the emergency degree of the to-be-sent information meets a first preset condition;
determining the non-dedicated licensed frequency band as the target frequency band for the to-be-sent information if the information type of the to-be-sent information is the monitoring type and the emergency degree of the to-be-sent information meets a second preset condition; or
determining the dedicated licensed frequency band as the target frequency band for the to-be-sent information if the information type of the to-be-sent information is the monitoring type and the emergency degree of the to-be-sent information meets a third preset condition, wherein an emergency degree corresponding to the third preset condition is higher than an emergency degree corresponding to the first preset condition and an emergency degree corresponding to the second preset condition.

7. A method for transmitting information in a power communications system, wherein the method is applied to a power communications system that uses at least two frequency bands for wireless communication, frequency band licensing statuses of the at least two frequency bands are different, and the method comprises:
determining a target frequency band from the at least two frequency bands based on an emergency degree of information to be sent and a correspondence between the emergency degree and each of the at least two frequency bands; and
sending the to-be-sent information using the target frequency band.

8. The method according to claim 7, wherein the at least two frequency bands comprise at least two of a dedicated licensed frequency band, a non-dedicated licensed frequency band, and an unlicensed frequency band that are used by the power communications system.

9. The method according to claim 8, wherein the determining a target frequency band from the at least two frequency bands based on an emergency degree of to-be-sent information and a correspondence between the emergency degree and each of the at least two frequency bands comprises:
determining the unlicensed frequency band as the target frequency band for the to-be-sent information if the emergency degree of the to-be-sent information meets a first preset condition;
determining the non-dedicated licensed frequency band as the target frequency band for the to-be-sent information if the emergency degree of the to-be-sent information meets a second preset condition; or
determining the dedicated licensed frequency band as the target frequency band for the to-be-sent information if the emergency degree of the to-be-sent information meets a third preset condition, wherein an emergency degree corresponding to the third preset condition is higher than an emergency degree corresponding to the first preset condition and an emergency degree corresponding to the second preset condition.

10. An apparatus for transmitting information in a power communications system, wherein the apparatus is applied to a power communications system that uses at least two frequency bands for wireless communication, frequency band licensing statuses of the at least two frequency bands are different, and the apparatus comprises:
a determining module configured to determine a target frequency band from the at least two frequency bands based on an information type of information to be sent and a correspondence between the information type and each of the at least two frequency bands; and
a sending module configured to send the to-be-sent information using the target frequency band determined by the determining module.

11. The apparatus according to claim 10, wherein the determining module comprises:
a first determining unit configured to determine a candidate target frequency band from the at least two frequency bands based on the information type of the to-be-sent information and the correspondence between the information type and each of the at least two frequency bands; and
a second determining unit configured to determine a target frequency band from the candidate target frequency band based on an emergency degree of the to-be-sent information.

12. The apparatus according to claim 10, wherein the at least two frequency bands comprise at least two of a dedicated licensed frequency band, a non-dedicated licensed frequency band, and an unlicensed frequency band that are used by the power communications system.

13. The apparatus according to claim 10, wherein the information type comprises a control type, a monitoring type, or a metering type.

14. The apparatus according to claim 13, wherein the determining module is configured to:
determine the dedicated licensed frequency band as the target frequency band for the to-be-sent information if the information type of the to-be-sent information is the control type;
determine the dedicated licensed frequency band, the unlicensed frequency band, or the non-dedicated licensed frequency band as the target frequency band for the to-be-sent information if the information type of the to-be-sent information is the monitoring type; or
determine the unlicensed frequency band or the non-dedicated licensed frequency band as the target frequency band for the to-be-sent information if the information type of the to-be-sent information is the metering type.

15. The apparatus according to claim 14, wherein when the information type of the to-be-sent information is the monitoring type, and the dedicated licensed frequency band, the unlicensed frequency band, or the non-dedicated licensed frequency band is determined as the target frequency band for the to-be-sent information, the determining module is configured to:
determine the unlicensed frequency band as the target frequency band for the to-be-sent information if the information type of the to-be-sent information is the monitoring type and the emergency degree of the to-be-sent information meets a first preset condition;
determine the non-dedicated licensed frequency band as the target frequency band for the to-be-sent information if the information type of the to-be-sent information is the monitoring type and the emergency degree of the to-be-sent information meets a second preset condition; or
determine the dedicated licensed frequency band as the target frequency band for the to-be-sent information if the information type of the to-be-sent information is the monitoring type and the emergency degree of the to-be-sent information meets a third preset condition, wherein
an emergency degree corresponding to the third preset condition is higher than an emergency degree corresponding to the first preset condition and an emergency degree corresponding to the second preset condition.

16. An apparatus for transmitting information in a power communications system, wherein the apparatus is applied to a power communications system that uses at least two frequency bands for wireless communication, frequency band licensing statuses of the at least two frequency bands are different, and the apparatus comprises:
a determining module configured to determine a target frequency band from the at least two frequency bands based on an emergency degree of information to be sent and a correspondence between the emergency degree and each of the at least two frequency bands; and
a sending module, configured to send the to-be-sent information using the target frequency band determined by the determining module.

17. The apparatus according to claim 16, wherein the at least two frequency bands comprise at least two of a dedicated licensed frequency band, a non-dedicated licensed frequency band, and an unlicensed frequency band that are used by the power communications system.

18. The apparatus according to claim 17, wherein the determining module is configured to:
determine the unlicensed frequency band as the target frequency band for the to-be-sent information if the emergency degree of the to-be-sent information meets a first preset condition;
determine the non-dedicated licensed frequency band as the target frequency band for the to-be-sent information if the emergency degree of the to-be-sent information meets a second preset condition; or
determine the dedicated licensed frequency band as the target frequency band for the to-be-sent information if the emergency degree of the to-be-sent information meets a third preset condition, wherein
an emergency degree corresponding to the third preset condition is higher than an emergency degree corresponding to the first preset condition and an emergency degree corresponding to the second preset condition.

19. A device for transmitting information in a power communications system, wherein the device is applied to a power communications system that uses at least two frequency bands for wireless communication, frequency band licensing statuses of the at least two frequency bands are different, and the device comprises:
a processor and a memory connected to the processor, wherein
the processor invokes an instruction stored in the memory to determine a target frequency band from the at least two frequency bands based on an information type of information to be sent and a correspondence between the information type and each of the at least two frequency bands; and
a transmitter, configured to send the to-be-sent information using the target frequency band.

20. The device according to claim 19, wherein the processor invokes an instruction stored in the memory to:
determine a candidate target frequency band from the at least two frequency bands based on the information type of the to-be-sent information and the correspondence between the information type and each of the at least two frequency bands; and
determine a target frequency band from the candidate target frequency band based on an emergency degree of the to-be-sent information.

21. The device according to claim 19, wherein the at least two frequency bands comprise at least two of a dedicated licensed frequency band, a non-dedicated licensed frequency band, and an unlicensed frequency band that are used by the power communications system.

22. The device according to claim 19, wherein the information type comprises a control type, a monitoring type, or a metering type.

23. The device according to claim 22, wherein the processor invokes an instruction stored in the memory to:
determine the dedicated licensed frequency band as the target frequency band for the to-be-sent information if the information type of the to-be-sent information is the control type;
determine the dedicated licensed frequency band, the unlicensed frequency band, or the non-dedicated licensed frequency band as the target frequency band for the to-be-sent information if the information type of the to-be-sent information is the monitoring type; or
determine the unlicensed frequency band or the non-dedicated licensed frequency band as the target frequency band for the to-be-sent information if the information type of the to-be-sent information is the metering type.

24. The device according to claim 23, wherein when the information type of the to-be-sent information is the monitoring type, and the dedicated licensed frequency band, the unlicensed frequency band, or the non-dedicated licensed frequency band is determined as the target frequency band for the to-be-sent information, the processor invokes an instruction stored in the memory to:
determine the unlicensed frequency band as the target frequency band for the to-be-sent information if the information type of the to-be-sent information is the monitoring type and the emergency degree of the to-be-sent information meets a first preset condition;
determine the non-dedicated licensed frequency band as the target frequency band for the to-be-sent information if the information type of the to-be-sent information is the monitoring type and the emergency degree of the to-be-sent information meets a second preset condition; or
determine the dedicated licensed frequency band as the target frequency band for the to-be-sent information if the information type of the to-be-sent information is the monitoring type and the emergency degree of the to-be-sent information meets a third preset condition, wherein
an emergency degree corresponding to the third preset condition is higher than an emergency degree corresponding to the first preset condition and an emergency degree corresponding to the second preset condition.

25. A device for transmitting information in a power communications system, wherein the device is applied to a power communications system that uses at least two frequency bands for wireless communication, frequency band licensing statuses of the at least two frequency bands are different, and the device comprises:
a processor and a memory connected to the processor, wherein
the processor invokes an instruction stored in the memory to determine a target frequency band from the at least two frequency bands based on an emergency degree of information to be sent and a correspondence between the emergency degree and each of the at least two frequency bands; and
a transmitter, configured to send the to-be-sent information using the target frequency band.

26. The device according to claim 25, wherein the at least two frequency bands comprise at least two of a dedicated licensed frequency band, a non-dedicated licensed frequency band, and an unlicensed frequency band that are used by the power communications system.

27. The device according to claim 26, wherein the processor invokes an instruction stored in the memory to:
determine the unlicensed frequency band as the target frequency band for the to-be-sent information if the emergency degree of the to-be-sent information meets a first preset condition;
determine the non-dedicated licensed frequency band as the target frequency band for the to-be-sent information if the emergency degree of the to-be-sent information meets a second preset condition; or
determine the dedicated licensed frequency band as the target frequency band for the to-be-sent information if the emergency degree of the to-be-sent information meets a third preset condition, wherein
an emergency degree corresponding to the third preset condition is higher than an emergency degree corresponding to the first preset condition and an emergency degree corresponding to the second preset condition.

28. A power communications system, wherein the power communications system uses at least two frequency bands for wireless communication, frequency band licensing statuses of the at least two frequency bands are different, the power communications system comprises:
a plurality of communications devices to perform power communication by sending and receiving information, wherein there is a correspondence between an information type of the information sent by each of the communications devices and one of the at least two frequency bands, and wherein when performing the power communication, each of the communications devices sends the information using a frequency band corresponding to the information type of the information.

29. The power communications system according to claim 28, wherein when the communications device sends the information using the frequency band corresponding to the information type of the information, each of the communications devices performs following operations:
when the information type of the information corresponds to the at least two frequency bands, determining a target frequency band from the at least two frequency bands based on an emergency degree of the information, and
sending the information using the target frequency band.

30. The power communications system according to claim 28, wherein
the at least two frequency bands comprise at least two of a dedicated licensed frequency band, a non-dedicated licensed frequency band, and an unlicensed frequency band that are used by the power communications system;
the information type comprises a control type, a monitoring type, or a metering type; and
that when performing the power communication, each of the communications devices sends the information by using a frequency band corresponding to the information type of the information comprises:
sending, by each of the communications devices, the information using the dedicated licensed frequency band if the information type of the information is the control type;
sending, by each of the communications devices, the information using the dedicated licensed frequency band, the unlicensed frequency band, or the non-dedicated licensed frequency band if the information type of the information is the monitoring type; or
sending, by each of the communications devices, the information using the unlicensed frequency band or the non-dedicated licensed frequency band if the information type of the information is the metering type.

31. The power communications system according to claim 30, wherein the sending, by each of the communications devices, the information using the dedicated licensed frequency band, the unlicensed frequency band, or the non-dedicated licensed frequency band if the information type of the information is the monitoring type comprises:
if the information type of the information is the monitoring type and the emergency degree of the information meets a first preset condition, determining the unlicensed frequency band as the target frequency band for the information, and sending the information by using the target frequency band;
if the information type of the information is the monitoring type and the emergency degree of the information meets a second preset condition, determining the non-dedicated licensed frequency band as the target frequency band for the information, and sending the information by using the target frequency band; or
if the information type of the information is the monitoring type and the emergency degree of the information meets a third preset condition, determining the dedicated licensed frequency band as the target frequency band for the information, and sending the information by using the target frequency band, wherein
an emergency degree corresponding to the third preset condition is higher than an emergency degree corresponding to the first preset condition and an emergency degree corresponding to the second preset condition.

32. A power communications system, wherein at least two frequency bands are used by the power communications system for wireless communication, frequency band licensing statuses of the at least two frequency bands are different,
the power communications system comprises a plurality of communications devices to perform power communication by sending and receiving information, wherein each of the communications devices determines a target frequency band from the at least two frequency bands based on an emergency degree of information to be sent and a correspondence between the emergency degree and each of the frequency bands, and sends the to-be-sent information using the target frequency band.

33. The power communications system according to claim 32, wherein the at least two frequency bands comprise at least two of a dedicated licensed frequency band, a non-dedicated licensed frequency band, and an unlicensed frequency band that are used by the power communications system.

34. The power communications system according to claim 33, wherein the unlicensed frequency band is determined as the target frequency band for the to-be-sent information if the emergency degree of the to-be-sent information meets a first preset condition;
the non-dedicated licensed frequency band is determined as the target frequency band for the to-be-sent information if the emergency degree of the to-be-sent information meets a second preset condition; or
the dedicated licensed frequency band is determined as the target frequency band for the to-be-sent information if the emergency degree of the to-be-sent information meets a third preset condition, wherein
an emergency degree corresponding to the third preset condition is higher than an emergency degree corresponding to the first preset condition and an emergency degree corresponding to the second preset condition.
